(19) United States
(12) Patent Application Publication
(10) Pub. No.: US 2017/0123931 A1
(43) Pub. Date: May 4, 2017

(54) Object Storage System with a Distributed Namespace and Snapshot and Cloning Features

(71) Applicant: Nexenta Systems, Inc., Santa Clara, CA (US)

(72) Inventors: Alexander AIZMAN, Mountain View, CA (US); Caitlin BESTLER, Sunnyvale, CA (US)

(21) Appl. No.: 14/931,732

(22) Filed: Nov. 3, 2015

(51) Int. Cl. G06F 11/14; G06F 17/30

(52) U.S. Cl. CPC G06F 11/1448; G06F 17/30581; G06F 2201/84

(57) ABSTRACT

The present invention relates to a distributed object storage system that supports snapshots and clones without requiring any form of distributed locking—or any form of centralized processing. A clone tree can be modified in isolation and the modifications then either discarded or merged into the main tree of the distributed object storage system.

### CROSS REFERENCE TO RELATED APPLICATIONS

This application builds upon the inventions of: U.S. patent application Ser. No. 14/258,791, filed on Apr. 22, 2014 and titled “SYSTEMS AND METHODS FOR SCALABLE OBJECT STORAGE”; U.S. patent application Ser. No. 14/258,791 is: a continuation of U.S. patent application Ser. No. 13/624,593, filed on Sep. 21, 2012, titled “SYSTEMS AND METHODS FOR SCALABLE OBJECT STORAGE,” and issued as U.S. Pat. No. 8,745,095; a U.S. patent application Ser. No. 13/209,342, filed on Aug. 12, 2011, titled “CLOUD STORAGE SYSTEM WITH DISTRIBUTED METADATA,” and issued as U.S. Pat. No. 8,533,231; U.S. patent application Ser. No. 13/415,742, filed on Mar. 8, 2012, titled “UNIFIED LOCAL STORAGE SUPPORTING FILE AND CLOUD OBJECT ACCESS” and issued as U.S. Pat. No. 8,849,759; U.S. patent application Ser. No. 14/095,839, which was filed on Dec. 3, 2013 and titled “SCALABLE TRANSPORT SYSTEM FOR MULTICAST REPLICATION”; U.S. patent application Ser. No. 14/095,843, which was filed on Dec. 3, 2013 and titled “SCALABLE TRANSPORT SYSTEM FOR MULTICAST REPLICATION”; U.S. patent application Ser. No. 14/095,848, which was filed on Dec. 3, 2013 and titled “SCALABLE TRANSPORT WITH CLIENT-CONSENSUS RENDEZVOUS”; U.S. patent application Ser. No. 14/095,855, which was filed on Dec. 3, 2013 and titled “SCALABLE TRANSPORT WITH CLUSTER-CONSENSUS RENDEZVOUS”; U.S. Patent Application No. 62/040,962, which was filed on Aug. 22, 2014 and titled “SYSTEMS AND METHODS FOR MULTICAST REPLICATION BASED ERASURE ENCODING;” U.S. Patent Application No. 62/098,727, which was filed on Dec. 31, 2014 and titled “CLOUD COPY ON WRITE (CCOW) STORAGE SYSTEM ENHANCED AND EXTENDED TO SUPPORT POSIX FILES, ERASURE ENCODING AND BIG DATA ANALYTICS”; and U.S. patent application Ser. No. 14/820,471, which was filed on Aug. 6, 2015 and titled “Object Storage System with Local Transaction Logs, A Distributed Namespace, and Optimized Support for User Directories.”

All of the above-listed application and patents are incorporated by reference herein and referred to collectively as the “Incorporated References.”

### TECHNICAL FIELD

The present invention relates to distributed object storage systems that support hierarchical user directories within its namespace. The namespace itself is stored as a distributed object. When a new object is added or updated as a result of a put transaction, metadata relating to the object's name eventually is stored in a namespace manifest shard based on the partial key derived from the full name of the object. A snapshot can be taken of the namespace manifest at a specific moment in time to create a snapshot manifest. A clone manifest can be created from a snapshot manifest and thereafter can be updated in response to put operations. A clone manifest can be merged into a snapshot manifest or to the namespace manifest and set of current version links, thereby enabling users to modify objects in a distributed manner. The prior art includes snapshots, clones and the clone/modify/merge update pattern are as to hierarchically controlled storage systems. However, the present invention provides a system and method of implementing these useful features in a fully distributed storage cluster that has no central points of processing and does so without requiring any form of distributed locking.

### BACKGROUND OF THE INVENTION

In traditional copy-on-write file systems, low cost snapshots of a directory or an entire file system can be created by simply not deleting the root of the namespace when later versions are created. Examples of copy-on-write file systems includes the ZFS file system developed by Sun Microsystems and the WAFL (Write Anywhere File Layout) file system developed by Network Appliance.

Non copy-on-write file systems have to pause processing long enough to copy metadata from the directory metadata to form the snapshot metadata. Many of these systems will retain the payload data as long as it is referenced by metadata. For those systems, no bulk payload copying is required. Others will have to copy the object data as well its metadata to create a snapshot.

However, these techniques all rely upon a central processing point to take the snapshot before proceeding to the next transaction. A fully distributed object cluster, such as the types of clusters disclosed in the Incorporated References, does not have any central points of processing. Lack of any central processing points allows an object cluster to scale to far larger sizes than any cluster with central processing points.

What is needed for such a system, however, is a new solution to enable taking snapshots and forking a cloned version of a tree that does not interfere with the highly distributed processing enabled by such a system.

### SUMMARY OF THE INVENTION

One of the Incorporated References, U.S. patent application Ser. No. 14/820,471, filed on Aug. 6, 2015 and titled “Object Storage System with Local Transaction Logs, A Distributed Namespace, and Optimized Support for User Directories,” which is incorporated by reference herein, describes a technique used by the Nexenta Cloud Copy-on-Write (CCOW) Object Cluster that applies MapReduce techniques to build an eventually consistent namespace manifest distributed object that tracks all version manifests created within a hierarchical namespace. This is highly advantageous in that it avoids the bottlenecks associated with the relatively flat tenant/account and bucket/container methods common that other object clusters.

The present invention extends any method of collecting directory entries for an object cluster where the entries are write-once records that do not require updating when the referenced content is replicated or migrated to new locations. The Nexenta CCOW Object Cluster does this by referencing payload with the cryptographic hash of a chunk, and then locating that chunk within a multicast negotiating group determined by the cryptographic hash of either the chunk content or the object name. A CCOW namespace manifest distributed object automatically collects the version manifests created within a namespace. Snapshot manifests and clone manifests subset and/or extend this data for specific purposes.

Snapshot manifests allow creation of point-in-time subsets of a namespace manifest, thereby creating a “snapshot” of a distributed moving system. While subject to the same eventual consistency delay as the namespace manifest itself, the “snapshot” can be “instantaneous” in that there is no risk of cataloging a sense of inconsistent versions that reflect only an unpredictable subset of a compound transaction.

The challenge of taking a snapshot of a distributed system is that without a central point of processing, it is hard to catch the system at rest. In prior art systems, it becomes necessary to tell the entire cluster to cease initiating new action until after the “snapshot” is taken. This is not analogous to a “snapshot,” but is more akin to a Civil War era photograph where the subject of the photograph had to remain motionless long enough for the camera to gather enough light.

Following the photography analogy, a snapshot manifest is indeed a snapshot of the cluster taken in a single instant. However, like a snapshot taken with analog film, the photograph is not available until after it has been fully processed.

Another aspect of the present invention relates to support for the clone-modify-merge pattern traditionally used for updating software source repositories.

Source control systems (such as subversion (svn), mercurial and git) have a well-established procedure for modifying source files required to build a system. The user creates a branch of the repository, checks out a working directory from the branch, makes modifications on the branch, commits changes to the branch and finally submits the changes back to the mainline repository. For most development projects, there is an associated review process to approve merges pushed from branches.

This clone-modify-merge pattern is useful for most software development projects, but can also be used for operational and configuration data as well as to facilitate exclusive access to blocks or files without requiring a global lock manager.

The clone-modify-merge pattern is conventionally implemented by user-mode software using standard file-oriented APIs to access and modify the repository. Typically, there are multiple repositories, each associated with directly attached storage. Each repository is comprised of multiple files holding the metadata about the visible files visible to the user of the repository. This layered implementation provides for a stable and highly portable interface. But it is wasteful of raw IO capacity and disk space. It also relies on end-users refraining from directly manipulating the metadata encoding files themselves. For source code repositories these are generally not overriding concerns compared with stability and portability, but this may have more of an impact on using these tools for production data.

Source control systems have conventionally implemented this strategy above the file system, encoding repository metadata in additional files over local file systems. Older systems, such as CVS and subversion, use a central repository that checks out to and checks in from end user local file systems. Later systems have distributed repositories that push and pull to each other, while the user's working directory checks in and out of a local repository.

Both of these strategies implicitly assume the Direct-Attached-Storage (DAS) model where storage for a cluster is attached as small islands to specific servers. All synchronization between repositories involves actual network transfers between the repositories.

An object storage system that supported a clone-modify-merge pattern for updating content could apply deduplication across all storage, avoid unnecessary replication when push content from one repository to another, and use a common storage pool for the data under management no matter what state each piece was in. The conventional solution presumes separate DAS storage, which precludes sharing resources for identical content. Integrating and then hiding is inefficient. Having physically separate repositories undermines the benefits of cloud storage, makes the aggregate storage less robust, and wastes network bandwidth with repository-to-repository copies.

The present invention addresses both of these needs through the creation of “snapshot manifests” and “clone manifests.” A snapshot manifest is an object that collects directory entries for a selected set of version manifests and enables access through the snapshot manifest. The snapshot manifest can be built from information in an eventually consistent namespace manifest, allowing the ability to create point-in-time snapshots of subsets of the whole repository without requiring a central point of processing. It may also be built from any cached set of version manifests.

A clone manifest is a writable version of a snapshot manifest, which allows metadata about new uncommitted versions of objects to be efficiently segregated from the metadata describing committed objects. Conventional solutions rely on access controls and naming conventions to hide uncommitted data, but this is inefficient. It first merges the data, and then takes extra steps to hide the data from typical users, or it can conversely rely upon repositories being kept on physically separate servers.

The present invention uses snapshot manifests and clone manifests to implement many conventional storage features within a fully distributed object storage cluster.

### BRIEF DESCRIPTION OF THE DRAWINGS

FIG. 1 depicts a storage system described in the Incorporated References.

FIG. 2 depicts an embodiment of a storage system utilizing a distributed namespace manifest and local transaction logs for each storage server.

FIG. 3A depicts the relationship between an object name received in a put operation, namespace manifest shards, and the namespace manifest.

FIG. 3B depicts the structure of one types of entry that can be stored in a namespace manifest shard.

FIG. 3C depicts the structure of another type of entry that can be stored in a namespace manifest shard.

FIGS. 4A and 4B depict various phases of a put transaction in the storage system of FIG. 2.

FIG. 5 depicts a delayed update of the namespace manifest following the put transaction of FIGS. 4A and 4B.

FIG. 6 depicts the structures of an exemplary version manifest, chunk manifest, and payload chunks used by the embodiments.

FIGS. 7A, 7B, and 7C depict examples of different partial keys applied to the name metadata for a single object version.

FIG. 8 depicts a MapReduce technique for a batch update from numerous transaction logs to numerous namespace manifest shards.

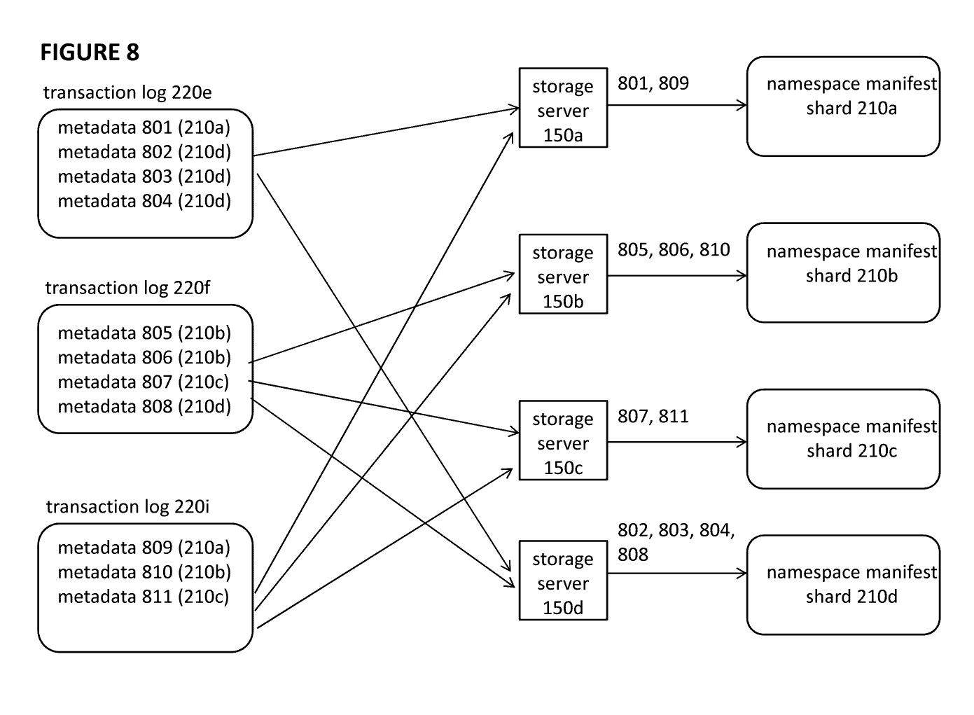

FIG. 9A depicts a partial key embodiment for namespace manifest shards.

FIG. 9B shows an iterative directory approach used in namespace manifest shards.

FIG. 9C shows an inclusive directory approach used in namespace manifest shards.

FIGS. 10A and 10B show the splitting of a namespace manifest shard.

FIGS. 11A and 11B show the splitting of all namespace manifest shards.

FIG. 12 depicts a clone creation method.

FIG. 13 depicts a snapshot creation method.

FIG. 14 depicts the creation of snapshot manifests at different instances of time.

FIG. 15 depicts an exemplary record within a snapshot manifest.

FIG. 16 depicts updating a snapshot manifest with records that were contained in transaction logs at the time of the snapshot.

FIG. 17 depicts an object space as a tree structure, a transaction log, and a snapshot as a snapshot as a tree structure.

FIG. 18 depicts an object space as multiple tree structures, a transaction log, and a snapshot as multiple tree structures.

FIG. 19 depicts the creation of a clone manifest from a portion or all of a namespace manifest.

FIG. 20 depicts the creation of a clone manifest from a snapshot manifest.

FIG. 21 depicts the creation of a clone manifest from a portion or all of a namespace manifest, modifications to the clone manifest, and subsequent merging of the modifications to the clone manifest into the namespace manifest.

FIG. 22 depicts the creation of a first clone manifest from a portion or all of a namespace manifest, modifications to the first clone manifest, the creation of a second clone manifest from a portion or all of an updated namespace manifest, modifications to the second clone manifest, and subsequent merging of the modifications to the first and second clone manifests into the namespace manifest.

FIG. 23 depicts a storage system comprising a namespace manifest and a clone manifest.

FIG. 24 depicts a process on a gateway server, typically referred to as a “daemon,” providing file or block access to local or remote client implemented over object services.

### DETAILED DESCRIPTION OF THE PREFERRED EMBODIMENTS

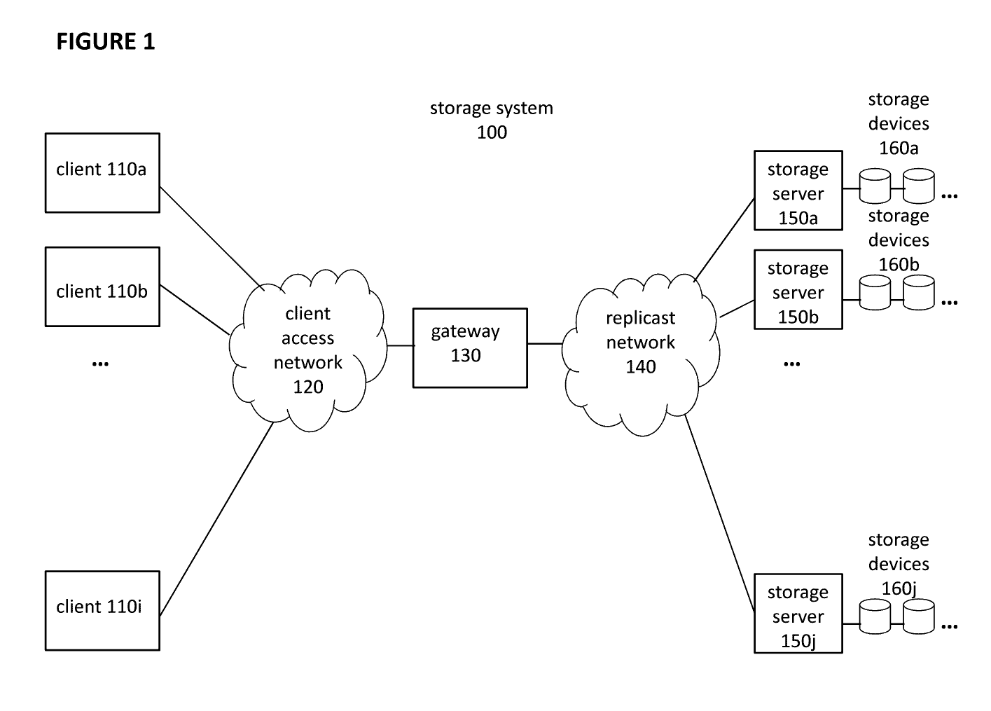

FIG. 1 depicts storage system 100 described in the Incorporated References. Storage system 100 comprises clients 110a, 110b, . . . 110i (where i is any integer value), which access gateway 130 over client access network 120. It will be understood by one of ordinary skill in the art that there can be multiple gateways and client access networks, and that gateway 130 and client access network 120 are merely exemplary. Gateway 130 in turn accesses Replicast Network 140, which in turn accesses storage servers 150a, 150b, . . . 150j (where j is any integer value). Each of the storage servers 150a, 150b, . . . , 150j is coupled to a plurality of storage devices 160a, 160b, . . . 160j, respectively.

Overview of Embodiments

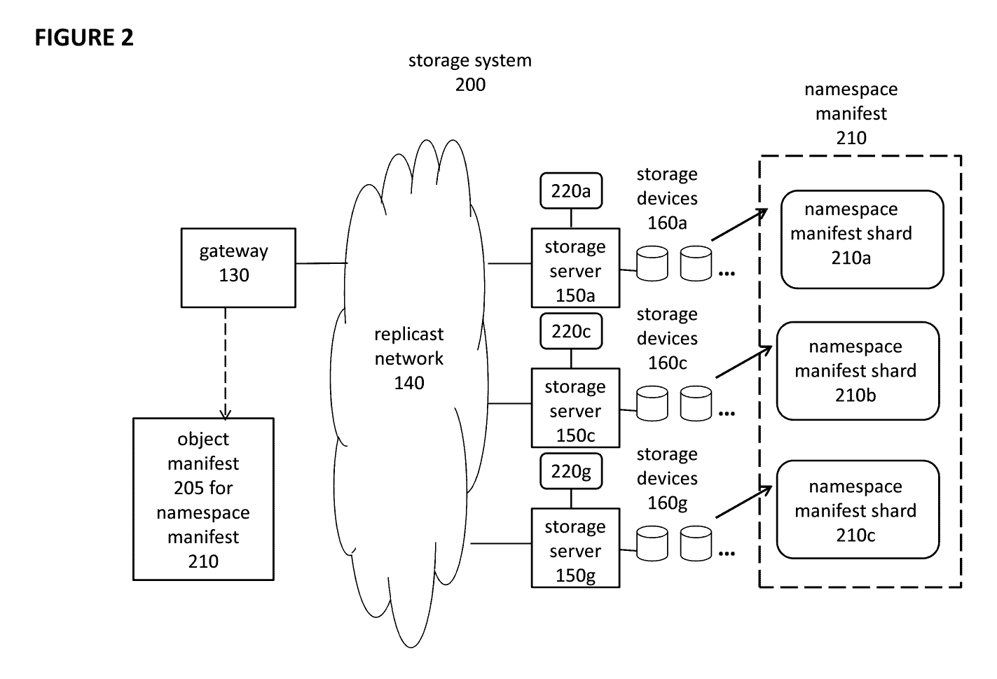

FIG. 2 depicts certain aspects of storage system 200, which is an embodiment of the invention. Storage system 200 shares many of the same architectural features as storage server 100, including the use of representative gateway 130, replicast network 140, storage servers, and a different plurality of storage devices connected to each storage server.

Storage servers 150a, 150c, and 150g here are illustrated as exemplary storage servers, and it is to be understood that the description herein applies equally to the other storage servers such as storage servers 150b, 150c, . . . 150j (not shown in FIG. 2). Similarly, storage devices 160a, 160c, and 160g are illustrated here as exemplary storage devices, and it is to be understood that the description herein applies equally to the other storage devices such as storage devices 160b, 160c, . . . , 160j (not shown in FIG. 2).

Gateway 130 can access object manifest 205 for the namespace manifest 210. Object manifest 205 for namespace manifest 210 contains information for locating namespace manifest 210, which itself is an object stored in storage system 200. In this example, namespace manifest 210 is stored as an object comprising three shards, namespace manifest shards 210a, 210b, and 210c. This is representative only, and namespace manifest 210 can be stored as one or more shards. In this example, the object has been divided into three shards and have been assigned to storage servers 150a, 150c, and 150g. Typically each shard is replicated to multiple servers as described for generic objects in the Incorporated References. These extra replicas have been omitted to simplify the diagram.

The role of the object manifest is to identify the shards of the namespace manifest. An implementation may do this either as an explicit manifest which enumerates the shards, or as a management plane configuration rule which describes the set of shards that are to exist for each managed namespace. An example of a management plane rule would dictate that the TenantX namespace was to spread evenly over 20 shards anchored on the name hash of “TenantX”.

In addition, each storage server maintains a local transaction log. For example, storage server 150a stores transaction log 220a, storage server 150c stores transaction log 220c, and storage serve 150g stores transaction log 150g.

Namespace Manifest and Namespace Manifest Shards

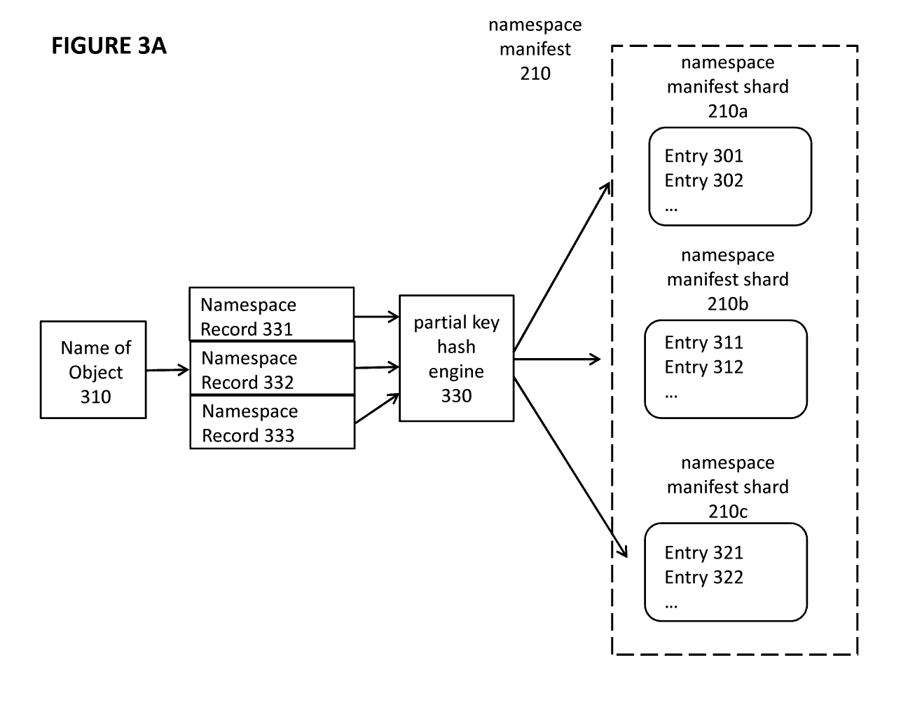

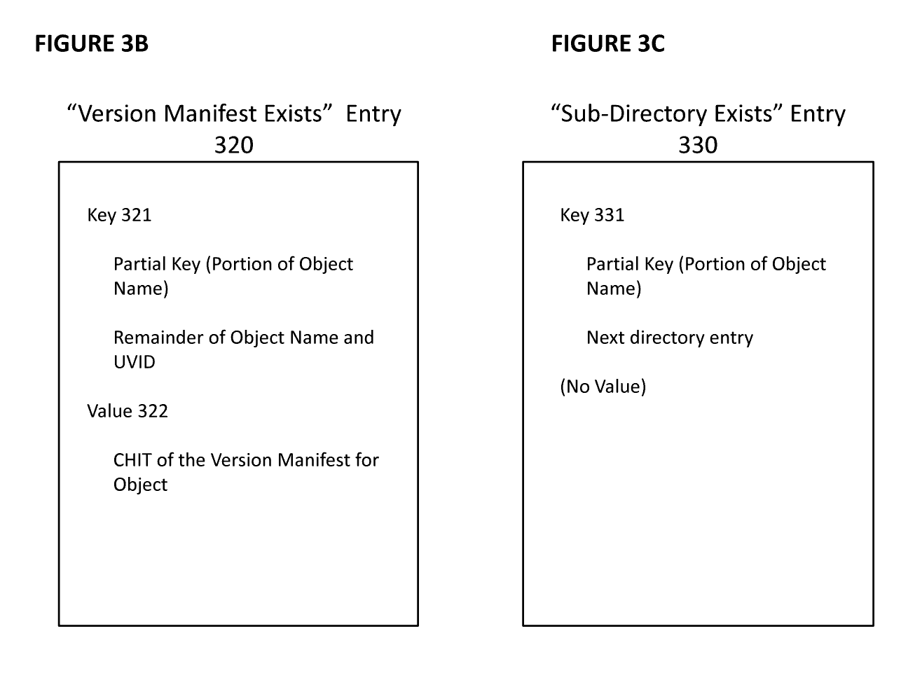

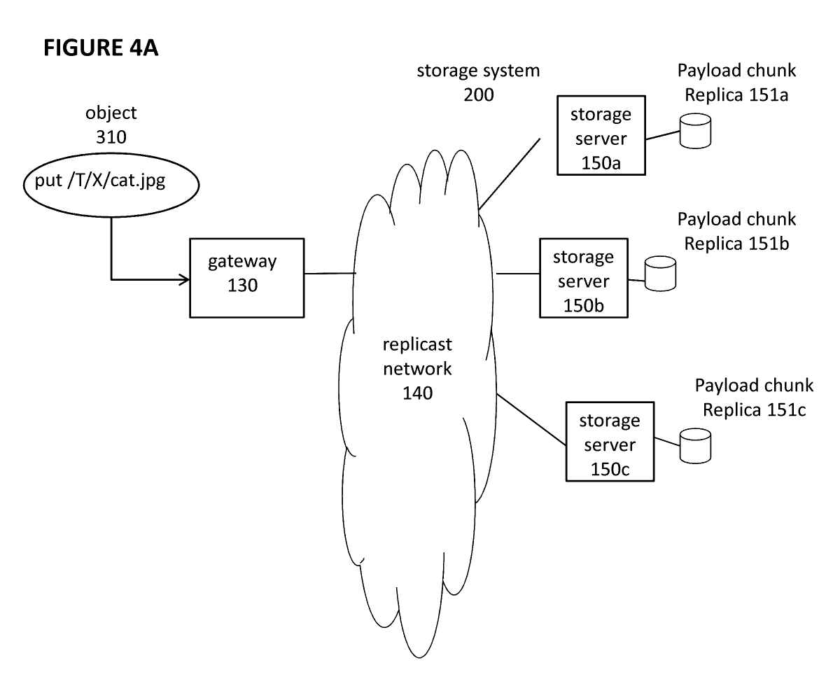

With reference to FIG. 3A, the relationship between object names and namespace manifest 210 is depicted. Exemplary name of object 310 is received, for example, as part of a put transaction. Multiple records (here shown as namespace records 331, 332, and 333) that are to be merged with namespace manifest 210 are generated using the iterative or inclusive technique previously described. The partial key has engine 330 runs a hash on a partial key (discussed below) against each of these exemplary namespace records 331, 332, and 333 and assigns each record to a namespace manifest shard, here shown as exemplary namespace manifest shards 210a, 210b, and 210c.

Each namespace manifest shard 210, 210b, and 210c can comprise one or more entries, here shown as exemplary entries 301, 302, 311, 312, 321, and 322.

The use of multiple namespace manifest shards has numerous benefits. For example, if the system instead stored the entire contents of the namespace manifest on a single storage server, the resulting system would incur a major non-scalable performance bottleneck whenever numerous updates need to be made to the namespace manifest.

Hierarchical directories make it very difficult to support finding objects under the outermost directory. The number of possible entries for the topmost directory is so large that placing all of those entries on a single set of servers would inevitably create a processing bottleneck.

The present invention avoids this potential processing bottleneck by allowing the namespace manifest to be divided first in any end-user meaningful way, for example by running separate namespace manifests for each tenant, and then by sharding the content using a partial key. Embodiments of the present invention divide the total combined namespace of all stored object versions into separate namespaces. One typical strategy for such division is having one namespace, and therefore one namespace manifest, per each one of the tenants that use storage cluster.

Generally, division of the total namespace into separate namespaces is performed using configuration rules that are specific to embodiments. Each separate namespace manifest is then identified by the name prefix for the portion of the total namespace. The sum (that is, logical union) of separate non-overlapping namespaces will form the total namespace of all stored object versions. Similarly, controlling the namespace redundancy, including the number of namespace shards for each of the resulting separate namespace manifests, is also part of the storage cluster management configuration that is controlled by the corresponding management planes in the embodiments of the present invention.

Therefore, the namespace record derived from each name of each object 310 is sharded using the partial key hash of each record. In the preferred embodiment, the partial key is formed by a regular expression applied to the full key. However multiple alternate methods of extracting a partial key from the whole key should be obvious to those skilled in the art. In the preferred embodiment, the partial key may be constructed so that all records referencing the same object will have the same partial key and hence be assigned to the same shard. For example, under this design, if record 320a and record 320b pertain to a single object (e.g., “cat.jpg”), they will be assigned to the same shard, such as namespace manifest shard 210a.

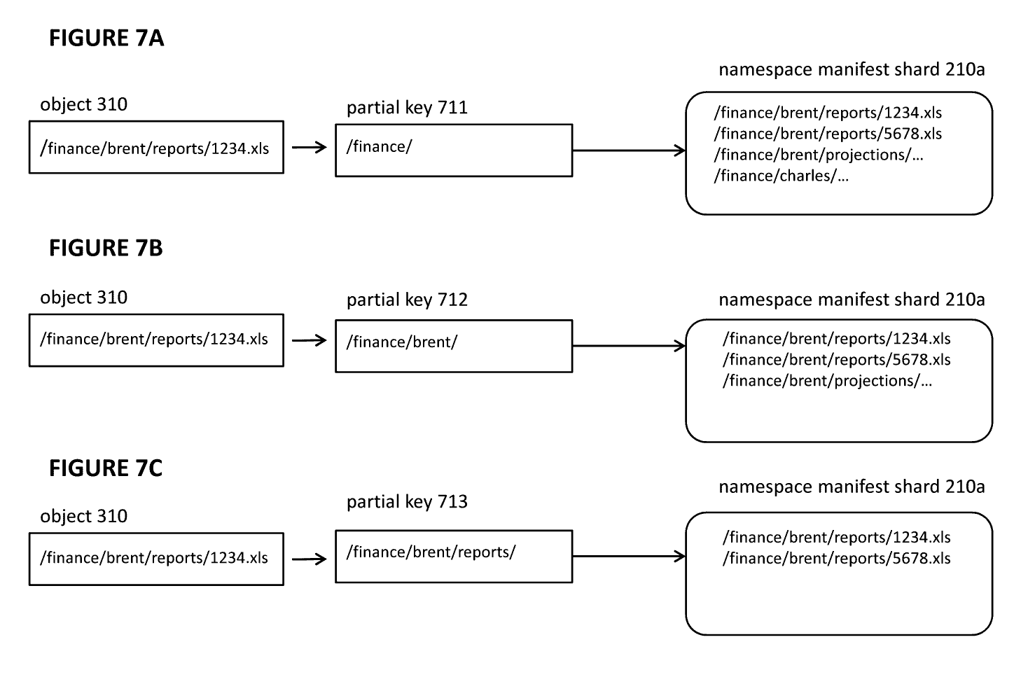

The use of partial keys is further illustrated in FIGS. 7A, 7B, and 7C. In FIGS. 7A, 7B, and 7C, object 310 is received. In these examples, object 310 has the name “/finance/brent/reports/1234.xls.” Three examples of partials keys are provided, partial keys 721, 722, and 723.

In FIG. 7A, the partial key “/finance/” is applied, which causes object 310 to be stored in namespace manifest shard 210a. In this example, other objects with names beginning with “/finance/” would be directed to namespace manifest shard 210 as well, including exemplary objects names “/finance/brent/reports/5678.xls,” “/finance/brent/projections/ . . . ” and “finance/Charles/ . . . ”.

In FIG. 7B, the partial key “/finance/brent/” is applied, which causes object 310 to be stored in namespace manifest shard 210a. In this example, other objects with names beginning with “/finance/brent/” would be directed to namespace manifest shard 210 as well, including exemplary objects “finance/brent/reports/5678.xls,” and “/finance/brent/projections/ . . . ”. Notably, objects beginning with “/finance/Charles/ . . . ” would not necessarily be directed to namespace manifest shard 210a, unlike in FIG. 7A.

In FIG. 7C, the partial key “/finance/brent/reports” is applied, which causes object 310 to be stored in namespace manifest shard 210a. In this example, other objects with names beginning with “/finance/brent/reports” would be directed to namespace manifest shard 210a as well, including exemplary object “finance/brent/reports/5678.xls.” Notably, objects beginning with “/finance/Charles/ . . . ” or “finance/brent/projections/ . . . ” would not necessarily be directed to namespace manifest shard 210a, unlike in FIGS. 7A and 7B.

It is to be understood that partial keys 721, 722, and 723 are merely exemplary and that partial keys can be designed to correspond to any level within a directory hierarchy.

With reference now to FIGS. 3B and 3C, the structure of two possible entries in a namespace manifest shard are depicted. These entries can be used, for example, as entries 301, 302, 311, 312, 321, and 322 in FIG. 3A.

FIG. 3B depicts a “Version Manifest Exists” entry 320, which is used to store an object name (as opposed to a directory that in turn contains the object name). Object name entry 320 comprises key 321, which comprises the partial key and the remainder of the object name and the UVID. In the preferred embodiment, the partial key is demarcated from the remainder of the object name and the UVID using a separator such as “|” and “\” rather than “/” (which is used to indicate a change in directory level). The value 322 associated with key 321 is the CHIT of the version manifest for the object 310, which is used to store or retrieve the underlying data for object 310.

FIG. 3C depicts “Sub-Directory Exists” entry 330. Sub-directory entry 330 comprises key 331, which comprises the partial key and the next directory entry.

For example, if object 310 is named “/Tenant/A/B/C/d.docx,” the partial key could be “/Tenant/A/”, and the next directory entry would be “B/”. No value is stored for key 331.

Delayed Revisions to Namespace Manifest In Response to Put Transaction

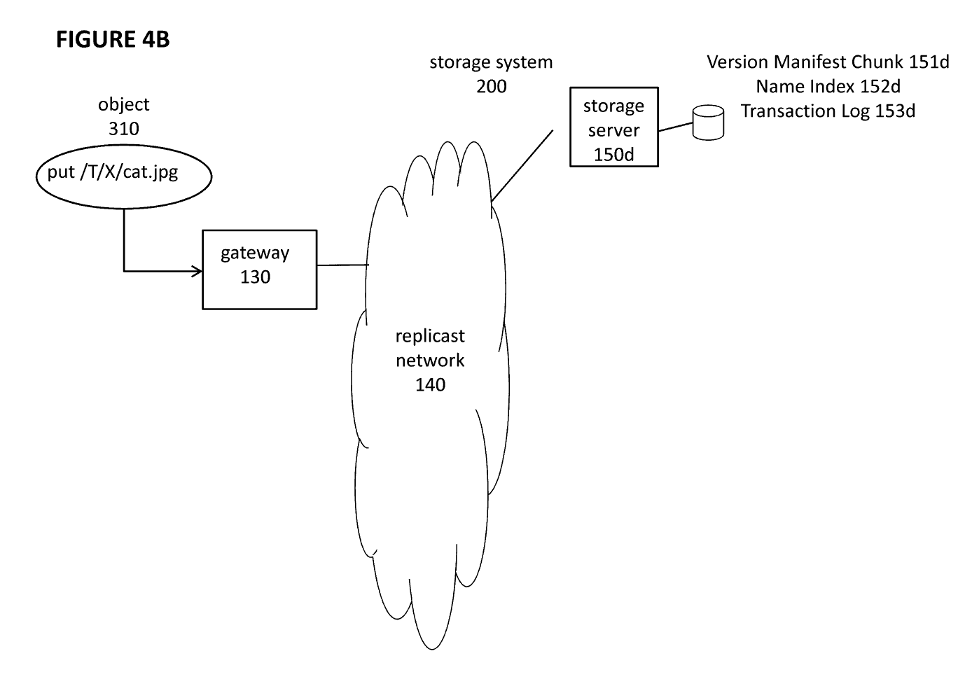

With reference to FIGS. 4A and 4B, an exemplary instruction is provided by a client, such as client 110a, to gateway 130. Here, the instruction is “put /T/S/cat.jpg,” which is an instruction to store the object 310 with the name “/T/S/cat.jpg.”

FIG. 4A depicts the first phase of the put transaction. Gateway 130 communicates this request over replicast network 140 as described in the Incorporated References. In this example, the payload of object 310 is stored as payload chunk replicas 151a, 151b, and 151c by storage servers 150a, 150b, and 150c, respectively, as discussed in the Incorporated References. Each storage server also stored intermediate manifests (not shown). Notably, each of the storage servers 150a, 150b, and 150c can acknowledge the storage of its payload chunk replica (151a, 151b and 151c) after it is created.

FIG. 4B depicts the second phase of the put transaction. In this example the version manifest for object 310 is to be stored by storage server 150d (as well as by other storage servers in a redundant manner). In response to this request, storage server 150d will write version manifest chunk 151 and update name index 152d for the names chunk if the new version manifest represents a more current version of the object. The existence of the version manifest for object 310 is recorded in transaction log 153d before the put transaction is acknowledged by storage servers 150a, 150b, and 150c (discussed previously with reference to FIG. 4A). This entry in the Transaction Log will be asynchronously processed at a later time. Notably, at this juncture, namespace manifest shards are not updated to reflect the put transaction involving object 310.

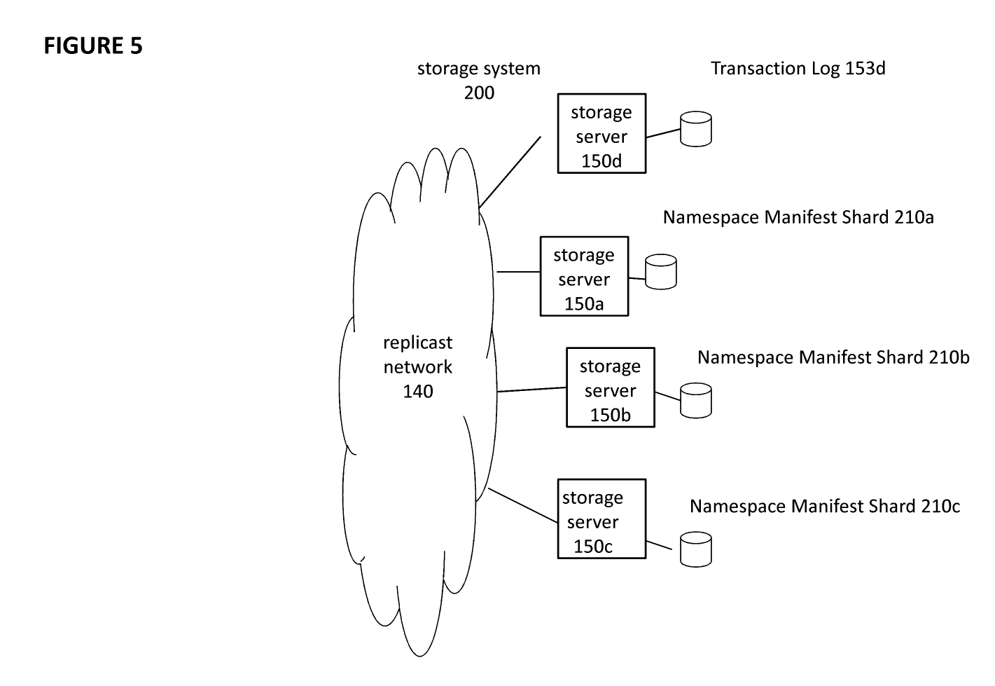

FIG. 5 illustrates a phase that occurs after the put transaction for object 310 (discussed above with reference to FIGS. 4A and 4B) has been completed. It is the “Map” phase of a MapReduce process. The entry in transaction log 153d reflecting the local creation of a version manifest 151d for object 310 are mapped to updates to one or more shards of the enclosing namespace manifest 210. Here, three shards exist, and the updates are made to namespace manifest shards 210a, 210b, and 210c.

The updating illustrated in FIG. 5 can occur during an “idle” period when storage server 150a and/or gateway 130 are not otherwise occupied. This eliminates latency associated with the put action of object 310 by at least one write cycle, which speeds up every put transaction and is a tremendous advantage of the embodiments. Optionally, the updating can occur in a batch process whereby a plurality of updates are made to namespace manifest 210 to reflect changes made by a plurality of different put transactions or other transactions, which increases the efficiency of the system even further. The merging of updates can even be deferred until there is a query for records in the specific shard. This would of course add latency to the query operation, but typically background operations would complete the merge operation before the first query operation anyway.

Version Manifests and Chunk Manifests

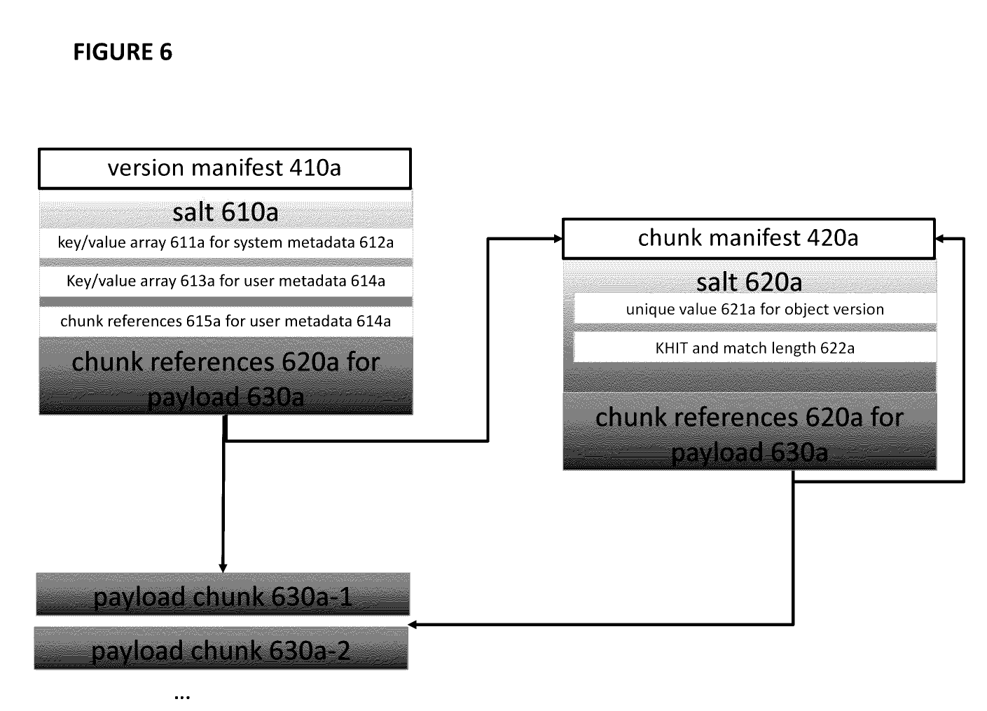

With reference to FIG. 6, additional detail will now be presented regarding version manifests and chunk manifests. In the present invention, object 310 has a name (e.g., “cat.jpg”). A version manifest, such as version manifest 410a, exists for each retained version of object 310.

FIG. 6 depicts version manifest 410a, chunk manifest 420a, and payload chunks 630a-1, 630a-2, . . . , 630a-k (where k is an integer), which together comprise the data portion of object 310.

Each manifest, such as namespace manifest 210, version manifest 410a, and chunk manifest 420a, optionally comprises a salt (which guarantees the content of the manifest is unique) and an array of chunk references.

For version manifest 410a, the salt 610a comprises:
A key/value array 611a of name=value pairs for the system metadata 612a. The system metadata 612a must include key/value name pairs that uniquely identify the object version for object 310.
Additional key/value entries 613a and/or chunk references 615a for additional user metadata 614a. User metadata 614a optionally may reference a content manifest holding metadata.

Version manifest 410a also comprises chunk references 620a for payload 630a. Each of the chunk references 620a is associated with one the payload chunks 630a-1, . . . 630a-k. In the alternative, chunk reference 620a may specify chunk manifest 420a, which ultimately references payload chunk 630a-1, . . . 630a-k.

For chunk manifest 420a, the salt 620a comprises:
A unique value 621a for the object version being created, such as the transaction ID required for each transaction, as disclosed in the Incorporated References.
The KHIT and match length 622a that were used to select this chunk manifest 330a.

Chunk manifest 420a also comprises chunk references 620a for payload 630a. In the alternative, chunk manifest 420a may reference other chunk/content manifests, which in turn directly reference payload 630a or indirectly reference payload 630a through one or more other levels of chunk/content manifests. Each of the chunk references 620a is associated with one the payload chunks 630a-1, . . . 630a-k.

Chunk references 620a may be indexed either by the logical offset and length, or by a hash shard of the key name (the key hash identifying token or KHIT). When indexed by logical offset and length, the chunk reference identifies an ascending non-overlapping offset within the object version. When indexed by hash shard, the reference supplies a base value and the number of bits that an actual hash of a desired key value must match for this chunk reference to be relevant. The chunk reference then includes either inline content or a content hash identifying token (CHIT) referencing either a sub-manifest or a payload chunk.

Namespace manifest 210 is a distributed versioned object that references version manifests, such as version manifest 410a, created within the namespace. Namespace manifest 210 can cover all objects in the cluster or can be maintained for any subset of the cluster. For example, in the preferred embodiments, the default configuration tracks a namespace manifest for each distinct tenant that uses the storage cluster.

Flexibility of Data Payloads within the Embodiments

The present embodiments generalize the concepts from the Incorporated References regarding version manifest 410a and chunk manifest 420a. Specifically, the present embodiments support layering of any form of data via manifests. The Incorporated References disclose layering only for chunk manifest 420a and the user of byte-array payload. By contrast, the present embodiments support two additional forms of data beyond byte-array payloads:
Key/value records, where each record is uniquely identified by a variable length full key that yields a variable length value.
Line oriented text, where a relative line number identifies each line-feed separated text line. The number assigned to the first line in an object version is implementation dependent but would typically be either 0 or 1.

The line-array and byte-array forms can be viewed as being key/value data as well. They have implicit keys that are not part of the payload. Being implicit, these keys are neither transferred nor fingerprinted. For line oriented payload, the implicit key is the line number. For byte-array payload, a record can be formed from any offset within the object and specified for any length up to the remaining length of the object version.

Further, version manifest 410a encodes both system and user metadata as key/value records.

This generalization of the manifest format allows the manifests for an object version to encode more key/value metadata than would have possibly fit in a single chunk.

Hierarchical Directories

In these embodiments, each namespace manifest shard can store one or more directory entries, with each directory entry corresponding to the name of an object. The set of directory entries for each namespace manifest shard corresponds to what would have been a classic POSIX hierarchical directory. There are two typical strategies, iterative and inclusive, that may be employed; each one of this strategies may be configured as a system default in the embodiments.

In the iterative directory approach, a namespace manifest shard includes only the entries that would have been directly included in POSIX hierarchical directory. A sub-directory is mentioned by name, but the content under that sub-directory is not included here. Instead, the accessing process must iteratively find the entries for each named sub-directory.

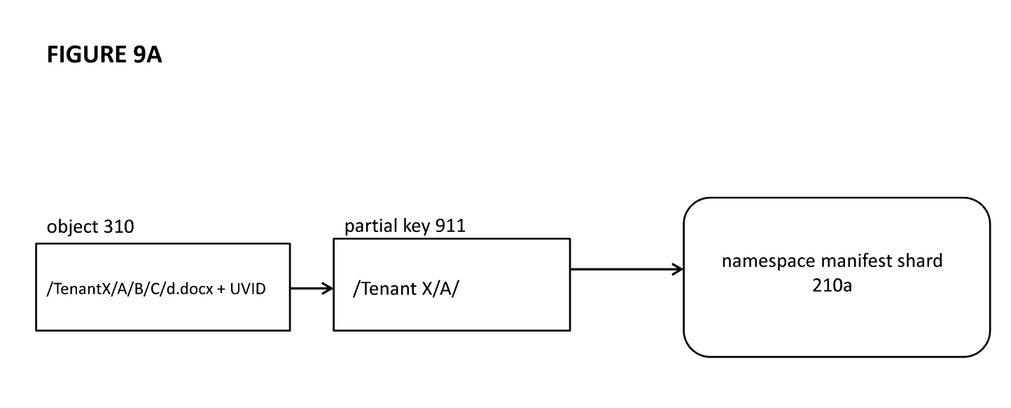

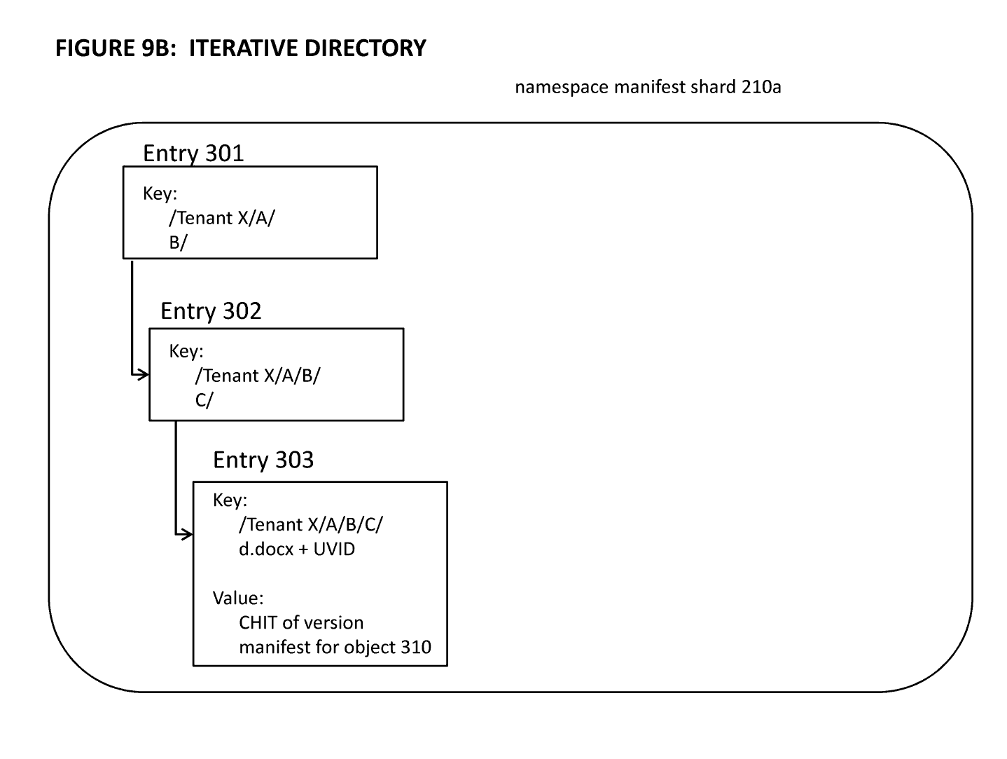

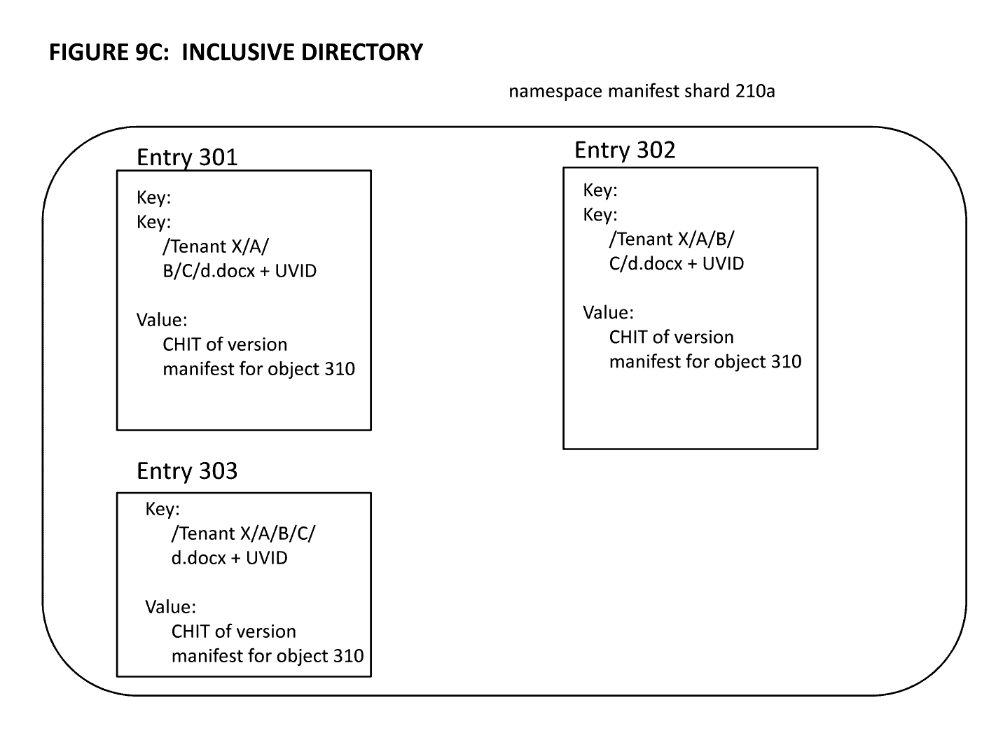

FIG. 9A depicts an example for both approaches. In this example, object 310 has the name “/TenantX/A/B/C/d.docx,” and the partial key 921 (“/TenantX/A/”) is applied to store the name of object 310 in namespace manifest shard 210a. Here, object 310 is stored in namespace manifest shard 210a in conjunction with a put transaction for object 310.

FIG. 9B shows the entries stored in namespace manifest shard 210a under the iterative directory approach. Under this approach, entry 301 is created as a “Sub-Directory Exists” entry 330 and indicates the existence of sub-directory /B. Entry 301 is associated with entry 302, which is created as a “Sub-Directory Exists” entry 330) and indicates the existence of sub-directory /C. Entry 302 is associated with entry 303, which is created as a “Version Manifest Exists” entry 320 and lists object 310 as “d.docx+UVID”.

FIG. 9C shows the entries stored in namespace manifest shard 210a under the inclusive directory approach. In the inclusive directory approach, all version manifests within the hierarchy are included, including content under each sub-directory. Entry 301 is created as a “Version Manifest Exists” entry 320 and lists the name B/C/d.docx+UVID. Entry 302 is created as a “Sub-Directory Exists” entry 330 and lists sub-directory B/. Entry 302 is associated with entries 303 and 304. Entry 303 is created as a “Sub-Directory Exists” entry 330 and lists /C.d.docx+UVID. Entry 304 is created as a “Sub-Directory Exists” entry 330 and lists directory C/, Entry 304 is associated with Entry 305, which is created as a “Version Manifest Exists” entry 320 and lists the name d.docx+UVID. This option optimizes searches based on non-terminal directories but requires more entries in the namespace manifest. As will be apparent once the updating algorithm is explained, there will typically be very few additional network frames required to support this option.

The referencing directory is the partial key, ensuring that unless there are too many records with that partial key that they will all be in the same shard. There are entries for each referencing directory combined with:
Each sub-directory relative to the referencing directory.
And each version manifest for an object that would be placed directly within the referencing directory, or with the inclusive option all version manifests that would be within this referencing directory or its sub-directories.

Gateway 130 (e.g., the Putget Broker) will need to search for non-current versions in the namespace manifest 210. In the Incorporated References, the Putget Broker would find the desired version by getting a version list for the object. The present embodiments improves upon that embodiment by optimizing for finding the current version and performing asynchronous updates of a common sharded namespace manifest 210 instead of performing synchronous updates of version lists for each object.

With this enhancement, the number of writes required before a put transaction can be acknowledged is reduced by one, as discussed above with reference to FIG. 5. This is a major performance improvement for typical storage clusters because most storage clusters have a high peak to average ratio. The cluster is provisioned to meet the peak demand, leaving vast resources available off-peak. Shifting work from the pre-acknowledgment critical path to background processing is a major performance optimization achieved at the very minor cost of doing slightly more work when seeking to access old versions. Every put transaction benefits from this change, while only an extremely small portion of the get transaction results in additional work being performed.

Queries to find all objects “inside” of a hierarchical directory will also be optimized. This is generally a more common operation than listing non-current versions. Browsing current versions in the order implied by classic hierarchical directories is a relatively common operation. Some user access applications, such as Cyberduck, routinely collect information about the “current directory.”

Distributing Directory Information to the Namespace Manifest

A namespace manifest 210 is a system object containing directory entries that are automatically propagated by the object cluster as a result of creating or expunging version manifests. Unlike user objects there is only the current version of a namespace manifest. Snapshot Manifests can be created to retain any subset of a namespace manifest as a frozen version.

The ultimate objective of the namespace manifest 210 is to support a variety of lookup operations including finding non-current (not the most recent) versions of each object. Another lookup example includes listing of all or some objects that are conceptually within a given hierarchical naming scope, that is, in a given user directory and, optionally, its sub-directories. In the Incorporated References, this was accomplished by creating list objects to track the versions for each object and the list of all objects created within an outermost container. These methods are valid, but require new versions of the lists to be created before a put transaction is acknowledged. These additional writes increase the time required to complete each transaction.

The embodiment of FIG. 5 will now be described in greater detail. Transaction logs 220a . . . 220g contain entries recording the creation or expunging of version manifests, such as version manifest 410a. Namespace manifest 210 is maintained as follows.

As each entry in a transaction log is processed, the changes to version manifests are generated as new edits for the namespace manifest 210.

The version manifest referenced in the transaction log is parsed as follows: The fully qualified object name found within the version manifest's metadata is parsed into a tenant name, one or more enclosing directories (typically based upon configurable directory separator character such as the ubiquitous forward slash (“/”) character), and a final relative name for the object.

Records are generated for each enclosing directory referencing the immediate name enclosed within in of the next directory, or of the final relative name. For the iterative option, this entry only specifies the relative name of the immediate sub-directory. For the inclusive option the full version manifest relative to this directory is specified.

With the iterative option the namespace manifest records are comprised of:
The enclosing path name: A concatenation of the tenant name and zero or more enclosing directories.
The next sub-directory name or the object name and unique identifier (UVID). If the latter, the version manifest content hash identifier (CHIT) is also included.

With the inclusive option the namespace manifest records are comprised of:
The enclosing path name: a concatenation of the tenant name and zero or more enclosing directories.
The remaining path name: A concatenation of the remaining directory names, the final object name and its unique version identifier (UVID).
The version manifest content hash identifier (CHIT).

A record is generated for the version manifest that fully identifies the tenant, the name within the context of the tenant and Unique Version ID (UVID) of the version manifest as found within the version manifest's metadata.

These records are accumulated for each namespace manifest shard 210a, 210b, 210c. The namespace manifest is sharded based on the key hash of the fully qualified name of the record's enclosing directory name. Note that the records generated for the hierarchy of enclosing directories for a typical object name will typically be dispatched to multiple shards.

Once a batch has accumulated sufficient transactions and/or time it is multicast to the Negotiating Group that manages the specific namespace manifest shard.

At each receiving storage server the namespace manifest shard is updated to a new chunk by applying a merge/sort of the new directory entry records to be inserted/deleted and the existing chunk to create a new chunk. Note that an implementation is free to defer application of delta transactions until convenient or there has been a request to get to shard.

In many cases the new record is redundant, especially for the enclosing hierarchy. If the chunk is unchanged then no further action is required. When there are new chunk contents then the index entry for the namespace manifest shard is updated with the new chunk's CHIT.

Note that the root version manifest for a namespace manifest does not need to be centrally stored on any specific, set of servers. Once a configuration object creates the sharding plan for a specific namespace manifest the current version of each shard can be referenced without prior knowledge of its CHIT.

Further note that each namespace manifest shard may be stored by any subset of the selected Negotiating Group as long as there are at least a configured number of replicas. When a storage server accepts an update from a source it will be able to detect missing batches, and request that they be retransmitted.

Continuous Update Option

The preferred implementation does not automatically create a version manifest for each revision of a namespace manifest. All updates are distributed to the current version of the target namespace manifest shard. The current set of records, or any identifiable subset, may be copied to a different object to create a frozen enumeration of the namespace or a subset thereof. Conventional objects are updated in discrete transactions originated from a single gateway server, resulting in a single version manifest. The updates to a namespace manifest arise on an ongoing basis and are not naturally tied to any aggregate transaction. Therefore, use of an implicit version manifest is preferable, with the creation of a specifically identified (frozen-in-time) version manifest of the namespace deferred until it is specifically needed.

Processing of a Batch for a Split Negotiating Group

Because distribution of batches is asynchronous, it is possible to receive a batch for a Negotiating Group that has been split. The receiver must split the batch, and distribute the half no longer for itself to the new negotiating group.

Transaction Log KVTs

The locally stored Transaction Log KVTs should be understood to be part of a single distributed object with key-value tuples. Each Key-Value tuple has a key comprised of a timestamp and a Device ID. The Value is the Transaction Log Entry. Any two subsets of the Transaction Log KVTs may be merged to form a new equally valid subset of the full set of Transaction Log KVTs.

In many implementations the original KVT capturing Transaction Log Entries on a specific device may optimize storage of Transaction Log Entries by omitting the Device ID and/or compressing the timestamp. Such optimizations do not prevent the full logical Transaction Entry from being recovered before merging entries across devices.

Namespace Manifest Resharding

An implementation will find it desirable to allow the sharding of an existing Namespace to be refined by either splitting a namespace manifest shard into two or more namespace manifest shards, or by merging two or more namespace shards into one namespace manifest shard. It is desirable to split a shard when there are an excessive records assigned to it, while it is desirable to merge shards when one or more of them have too few records to justify continued separate existence.

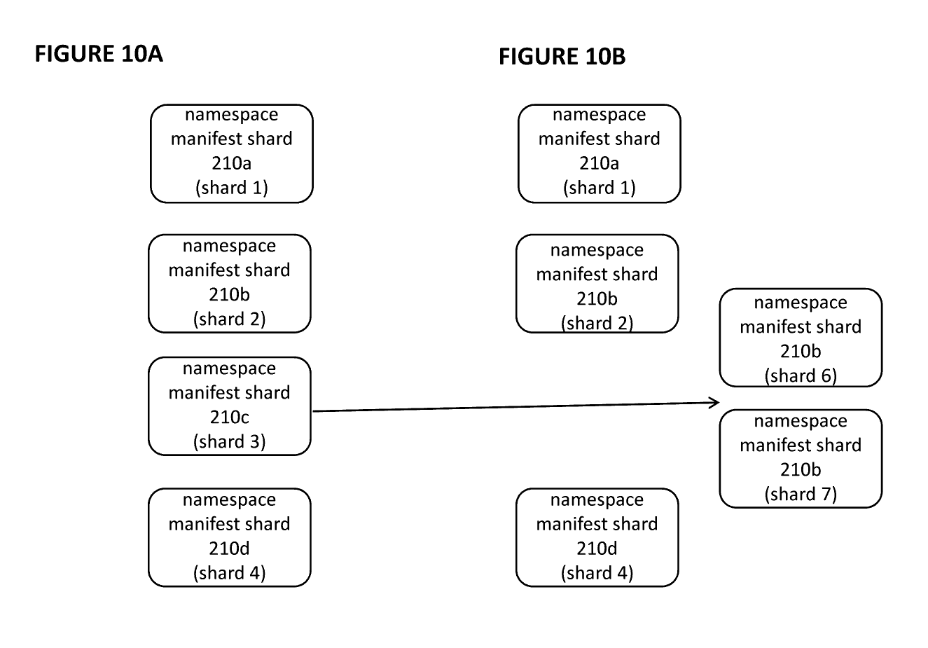

When an explicit Version Manifest has been created for a Namespace Manifest, splitting a shard is accomplished as follows:
As shown in FIGS. 10A and 10B, the Put Update request instructs the system to split a particular shard by using a modifier to request creating a second chunk with the records assigned to a new shard. In FIG. 10A, four exemplary shards are shown (M shards). If the current shard is N of M (e.g., shard 3 of 4) and the system is instructed to split the shard, the new shards, shown in FIG. 10B, will be N*2 of M*2 (e.g., shard 6 of 8) and N*2+1 of M*2 (e.g., shard 7 of 8), and shard N (e.g., shard 3) will cease to exist. The shards that are not splitting will retain their original numbering (i.e. non-N of M) (e.g., shards 1, 2, and 4 of 16).
As each targeted server creates its modified chunk, it will attempt to create the split chunk in the Negotiating Group assigned for the new shard (N*2+1 of M*2). Each will attempt to create the same new chunk, which will result in N-1 returns reporting that the chunk already exists. Both CHITs of the new chunks are reported back for inclusion of the new version manifest.

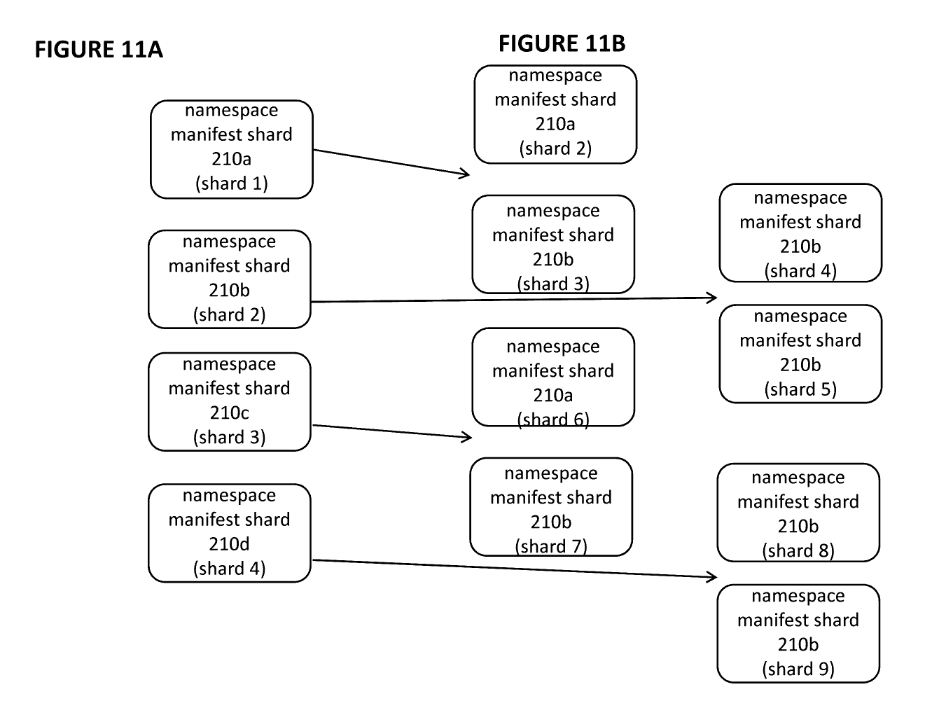

When operating without an explicit version manifest it is necessary to split all shards at once. This is done as follows and as shown in FIGS. 11A and 11B:
The policy object is changed so that the desired sharding is now M*2 rather than M (e.g., 8 shards instead of 4).
Until this process completes, new records that are to be assigned to shard N*2+1 (e.g., shard 7 when N=3) of M will also be dispatched to shard N*2 of M (e.g., shard 6).
A final instruct to each shard to split its current chunk with a Put Update request to insert no new records but requesting the spit to shard N*2 of M*2 and N*2+1 of M*2. This will result in many redundant records being delivered to the new “odd” shards, but splitting of Namespace Shards will be a relatively rare occurrence. After all, anything that doubled in capacity frequently on a sustained basis would soon consume all the matter in the solar system.
Redundant dispatching of “odd” new records is halted, resuming normal operations.

While relatively rare, the total number of records in a sharded object may decrease, eventually reaching a new version which would merge two prior shards into a single shard for the new version. For example, shards 72 and 73 of 128 could be merged to a single shard, which would be 36 of 64.

The put request specifying the new shard would list both 72/128 and 73/128 as providing the pre-edit records for the new chunk. The targets holding 72/128 would create a new chunk encoding shard 36 of 64 by merging the retained records of 72/128, 73/128 and the new delta supplied in the transaction.

Because this put operation will require fetching the current content of 73/128, it will take longer than a typical put transaction. However such merge transactions would be sufficiently rare and not have a significant impact on overall transaction performance.

Namespace manifest gets updated as a result of creating and expunging (deleting) version manifests. Those skilled in the art will recognize that the techniques and methods described herein apply to the put transaction that creates new version manifests as well as to the delete transaction that expunges version manifests. While specific embodiments of, and examples for, the invention are described herein for illustrative purposes, various equivalent modifications are possible within the scope of the invention. These modifications may be made to the invention in light of the above detailed description

Snapshots of the Namespace

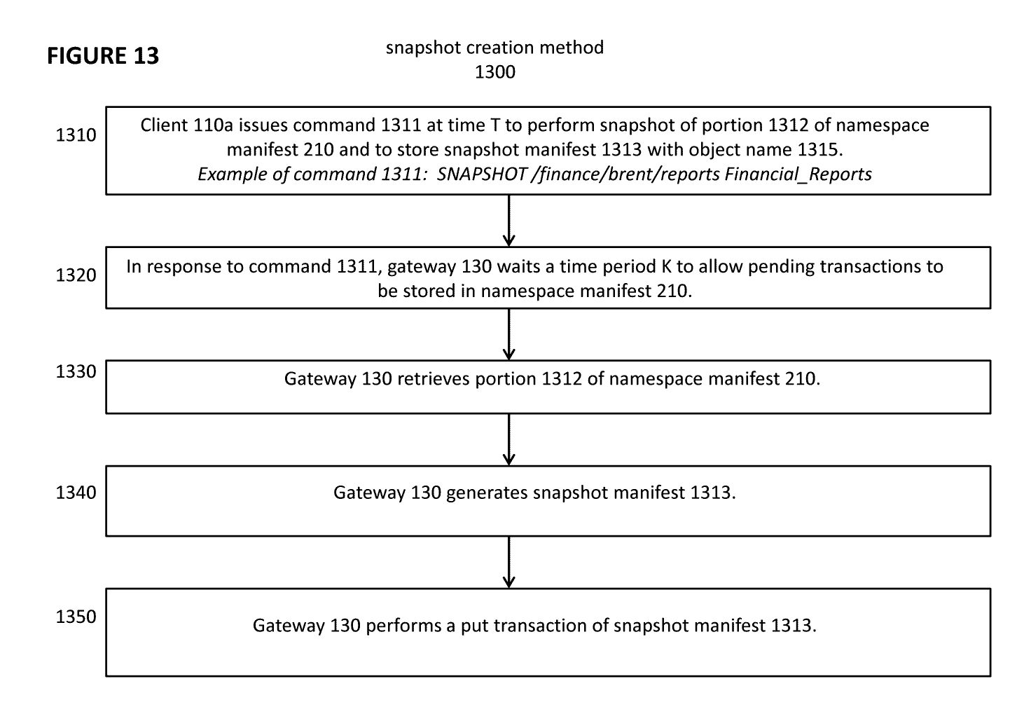

With reference to FIG. 13, snapshot creation method 1300 is depicted. Creation of a snapshot, or a new version of a snapshot, is typically initiated via a client 110a, 110b, . . . 110i by an administrator or by an automated management system that uses the corresponding client interface. For shortness sake, snapshot initiator denotes henceforth any client of the storage system that initiates snapshot creation.

First, exemplary a snapshot initiator (shown as client 110a) issues command 1311 at time T to perform a snapshot of portion 1312 of namespace manifest 210 and to store snapshot object 1313 with object name 1315. Portion 1312 can comprise the entire namespace manifest 210, or portion 1312 can be a sub-set of namespace manifest 210. For example, portion 1312 can be expressed as one or more directory entries or as a specific enumeration of one or more objects. An example of command 1311 would be: SNAPSHOT/finance/brent/reports Financial_Reports. In this example, “SNAPSHOT” is command 1311, “/finance/brent/reports” is the identification of portion 1312, and “Financial_Reports” is object name 1315. The command may be implemented in one of many different formats, including binary, textual, command line, or HTTP/REST. (Step 1310).

Second, in response to command 1311, gateway 130 waits a time period K to allow pending transactions to be stored in namespace manifest 210. (Step 1320).Third, gateway 130 retrieves portion 1312 of namespace manifest 210. This step involves retrieving the namespace manifest shards that correspond to portion 1312. (Step 1330).

Fourth, in response to command 1311, gateway 130 retrieves all transaction logs 220 and identifies all pending transactions 1331 at time T. (Step 1330). These records cannot be used for the snapshot until all transactions that were initiated at or before Time T are represented in one or more Namespace Manifest shards. Thus, a snapshot at Time T cannot be created until time T+K, where K represents an implementation-dependent maximum propagation delay. The delay of time K allows all transactions that are pending in transaction logs (such as transaction logs 220a . . . 220g) to be stored in the appropriate namespace shards. While the records for the snapshot cannot be collected before this minimal delay, they will still represent a snapshot at time T. It should be understood that allowing for a maximum delay requires allowing for congested networks and busy servers, which may compromise prompt availability of snapshots. An alternative implementation could use a multicast synchronization, such as found in the MPI standards, to confirm that all transactions as of time T have been merged into the namespace manifest.

Fifth, gateway 130 generates snapshot object 1313. This step involves parsing the entries of each namespace manifest shard to identify the entries that relate to portion 1312 (which will be necessary if portion 1312 does not align completely with the contents of a namespace manifest shard), storing the namespace manifest shards or entries in memory, storing all pending transactions 1331 pending at time T from all transaction logs 220, and creating snapshot object 1313 with object name 1315 (Step 1340).

Finally, gateway 130 performs a put transaction of snapshot object 1313 to store it. This step uses the same procedure described previously as to the storage of an object. (Step 1350).

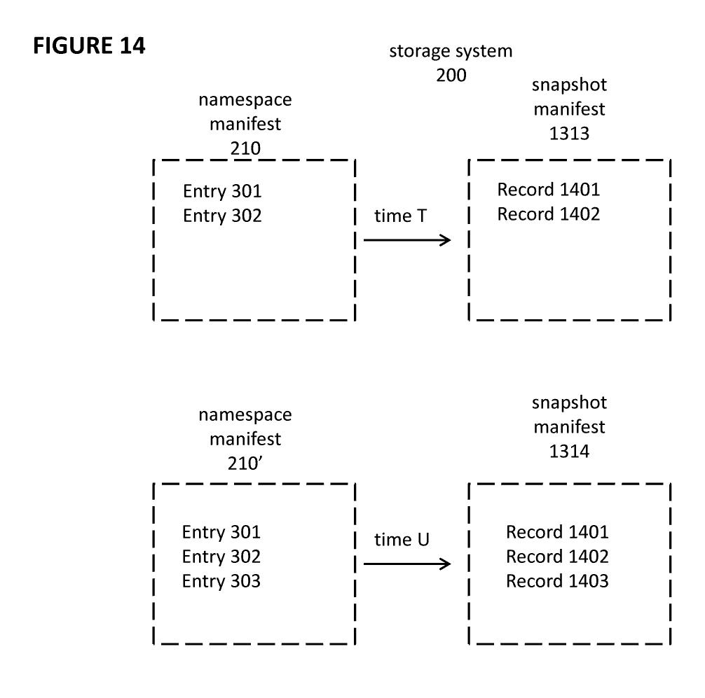

With reference to FIG. 14, two snapshots within storage system 200 are depicted for the simplified scenario where no transactions are pending in transaction logs 220 at the time of the snapshot. At time T, snapshot manifest 1313 is created from namespace manifest 210 or a portion thereof. At time U, snapshot manifest 1314 is created from namespace manifest 210′ or a portion thereof. Notably, at time U, the state of storage system 200 is different than it was at time T. In this example, namespace manifest 210′ contains entry 303 that was not present in namespace manifest 210.

As can be seen in FIG. 14, each record in the namespace manifest or a portion thereof results in the creation of a record in the snapshot manifest. Thus, record 1401 corresponds to entry 301, record 1402 corresponds to entry 302, and record 1403 corresponds to entry 303.

A snapshot manifest (such as snapshot manifest 1313 or 1314) is a sharded object that is created by a MapReduce job which selects a subset of records from a namespace manifest (such as namespace manifest 210) or a portion thereof, or another version of a snapshot manifest. The MapReduce job which creates a version of a snapshot manifest is not required to execute instantaneously, but the extract created will represent a snapshot of a subset of a namespace manifest at a specific point in time or of a specific snapshot manifest version.

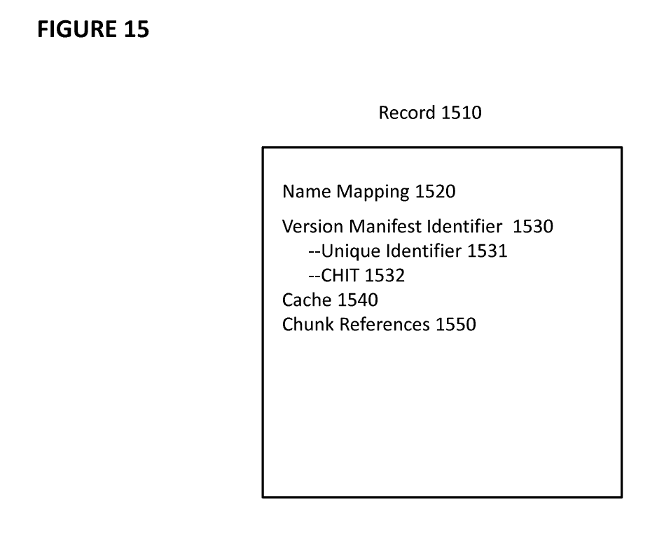

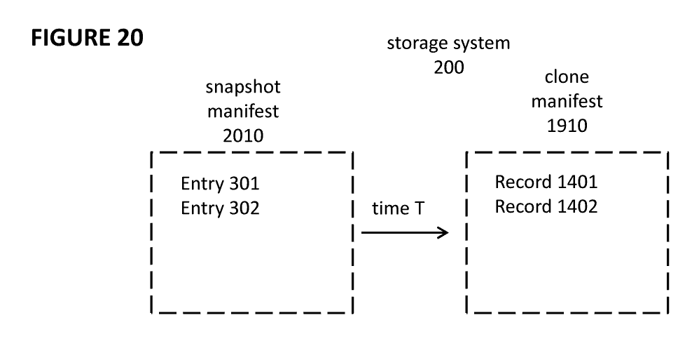

In FIG. 15, additional detail is shown regarding the content of an exemplary record 1510 within an exemplary snapshot manifest, such as snapshot manifest 1313 or 1314 (or 2010, discussed below with reference to FIG. 20). Records 1401, 1402, and 1403 in FIG. 14 follow the structure of record 1510 in FIG. 15.

Record 1510 comprises name mapping 1520. Name mapping 1520 encodes information for any name that corresponds to a conventional hierarchical directory found in the subject of the snapshot, such as namespace manifest 210 or 210′ or a portion thereof. Name mapping 1520 specifies the mapping of a relative name to a fully qualified name. This may merely document the existence of a sub-directory, or may be used to link to another name, effectively creating a symbolic link in the distributed object cluster namespace.

Record 1510 further comprises version manifest identifier 1530. Version manifest identifier 1530 identifies the existence of a specific version manifest by specifying at least the following information: (1) Unique identifier 1531 for the record, unique identifier 1531 comprising the fully qualified name of the enclosing directory, the relative name of the object, and a unique identifier of the version of the object. In the preferred embodiment, unique identifier 1531 comprises a transactional timestamp concatenated with a unique identifier of the source of the transaction. (2) Content hash-identifying token (CHIT) 1532 of the version manifest. (3) A cache 1540 of records from the version manifest to optimize their retrieval. These records have a value cached from the version manifest and the key for that record, which identifies the version manifest and the key value within the version manifest.

In the preferred embodiment, exemplary record 1510 follows a rule that a simple unique key yields a value. However, as should be obvious to those skilled in the art, the same information can also be encoded in a hierarchical fashion. For example an XML encoding could have one layer to specify the relative object name with zero or more nested XML sub-structures to encode each version manifest, with fields within the version manifest XML encoding.

For example, directory entries could be encoded in a flat organization as:
Key: “/tenant-X/root-A/dir-B/dir-C/”+“object.docx”+<unique version>
Value: <version-manifest-CHIT>

Or the same directory entries could be encoded in in an XML structure as:

<directory name=”/tenant-X/root-A/dir-B/dir-C/”>

<object name=”object.docx”>

<version = “unique version”>

<chit> = “long hex string”

</version>

</object name>

</directory name>

Record 1510 optionally comprises chunk references 1550. In a flat encoding, the key is formed by concatenating the version manifest key with the chunk reference identifier. In a hierarchical encoding, the chunk reference records are included within the content of the version manifest record.

In the preferred embodiment, the following chunk reference types are supported:
Logical Byte Offset+Logical Byte Length→Chunk CHIT.
Logical Byte Offset+Logical Byte Length→Inline data.
Logical Line Offset+Logical Line Length→Chunk CHIT.
Logical Line Offset→Inline data.
Partial Key Shard: as previously disclosed in [key-value records] and recapped in the following section.
Full Key Shard: as previously disclosed in [key-value records] and recapped in a later section.
Block Shard: as described in a later section.

The Partial Key Shard Chunk Reference is previously disclosed in the Incorporated References. Specific details are restated in this application because of their relevance. A Partial Key Shard Chunk Reference claims a subset of the potential namespace for referenced payload and specifies the CHIT of the current chunk for this shard. The current chunk may be either a Payload Chunk or a Manifest Chunk.

Partial Key Shard Chunk References are used with key/value data. A regular expression which must be included in the system metadata for the object governs mapping the full key to a partial key. The relevant cryptographic hash algorithm is then applied to the Partial Key to obtain the Partial Key hash.

Each Partial Key Shard Chunk Reference defines a shard of the aggregate key hash space, and assigns all keys to this shard by specifying:
The number of bits of a Partial Key Hash that must match for this Chunk Reference to apply.
The Partial Key Hash value that must be matched. Only the specified number of ms-bits are required.

A normal put operation will inherit the shards as defined for the referenced version, but will replace the referenced CHIT of the Manifest or Payload Chunk for this shard.

The Partial Key Shard Chunk Reference allows sets of related key/value records, for example all Snapshot Manifest records about a given Object, to be assigned to the same Shard. While this allows minor variations in the distribution of records across shards it reduces the number of shards that a transaction seeking all records matching a partial key must access.

In the unusual case that the Partial Key Chunk Reference selects more records than can be kept in a single Chunk, the referenced Manifest can use Full Key Shard Chunk References to sub-shard the records assigned to the partial-key specified shard.

The Full Key Shard Chunk Reference is previously disclosed in the Incorporated References. Specific details are restated in this application because of their relevance.

A Full Key Shard Chunk Reference is fully equivalent to the Partial Key Shard Chunk Reference except that the Key Hash is calculated on the record's full key. Full Key Shard Chunk References can be used to sub-shard a shard that has too many records for a single Payload Chunk to hold.

An object get may be specified to take place within the context of a specific version of a snapshot manifest. The object request will be satisfied against the version manifest enumerated within the snapshot manifest if possible, and then the object cluster as a whole if not (which would be required if the relevant portion of the namespace manifest was not part of the snapshot operation).

Rolling back to a snapshot manifest involves creating a current object version for each object within the snapshot manifest in the object cluster, where each new object version created:
Has the same chunk references and inline data chunks as the current object version within the snapshot.
Has the current time as its creation time, but includes the original creation time as a reserved metadata field. Because it has the current time as its creation time, it will become the current version of this object.

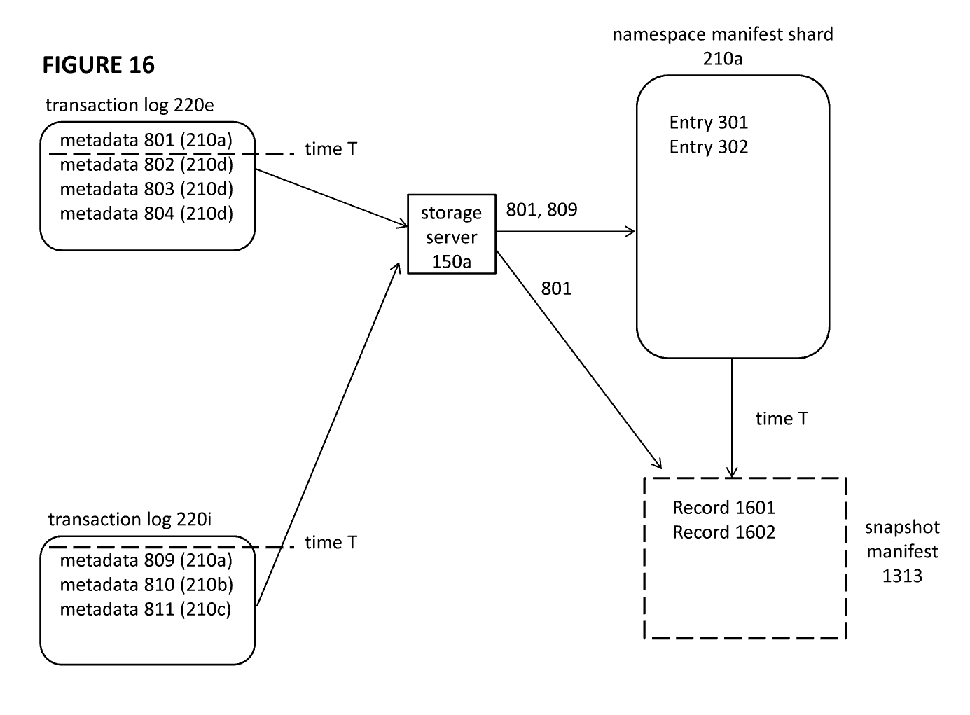

In the distributed storage cluster of the embodiments described herein, it would be desirable to be able to create a snapshot of the namespace manifest or a portion thereof without halting all processing in the storage cluster, even in the situation where transactions are pending. FIG. 16 depicts the more complicated example where a command to perform a snapshot at time T of namespace manifest 210 (or a portion thereof) is received while transactions are pending, that is, while transactions are contained in one or more transaction logs 220 that have not yet been added to the namespace manifest 210. The command may be implemented in one of many different formats, including binary, textual, command line, or HTTP/REST.

In FIG. 16, exemplary transaction logs 220e and 220i are shown. In transaction log 220e, the transaction associated with metadata 801 occurred before time T, while the transactions associated with metadata 802, 803, and 804 occurred after time T. In transaction log 220i, the transactions associated with metadata 809, 810, and 811 occurred after time T.

Under the embodiments previously discussed, the transactions from transaction logs 220e and 220i will be added to various namespace manifest shards, such as namespace manifest shard 210a, at some point in time. Because the snapshot is taken at time T, entries 301 and 302 are captured in snapshot manifest 1313, but metadata 801 also must be captured in snapshot manifest 1313. If we assume for this example, that metadata 801 contains a change to Entry 301 (for example, indicating a new version of an object), then that change will be reflected in Record 1401 in snapshot manifest 1313, either by modifying the data before it is stored as Record 1401, or by updating Entry 301 in namespace manifest shard 210a before it is copied as Record 1401 in snapshot manifest 1313.

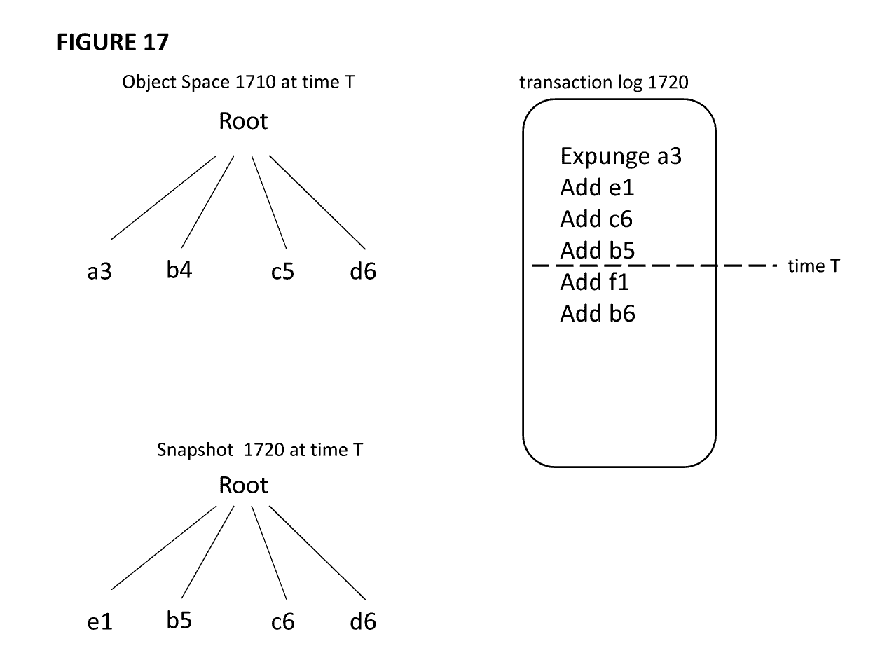

FIG. 17 contains another depiction of the snapshot creation. Transaction log 1720 contains various transactions that are not yet reflected in namespace manifest 210. Each transaction corresponds to one of the metadata fields in FIG. 16. Here, the transactions include: expunge object a3, add object e1, add object c6, and add object b5 before time T and add object f1 and add object b6 after time T. At time T, the relevant object space that is the subject of the snapshot command is shown as object space 1710, which comprises objects a3, b4, c5, and d6 in namespace manifest 210. However, when snapshot manifest 1720 is created, it will capture data from namespace manifest 210 as well as all data in transaction log 1720 for transactions that were received prior to time t. Thus, snapshot 1720 comprises objects e1, b5, c6, and d6, which reflects the transactions contained in transaction log 1720 prior to time T.

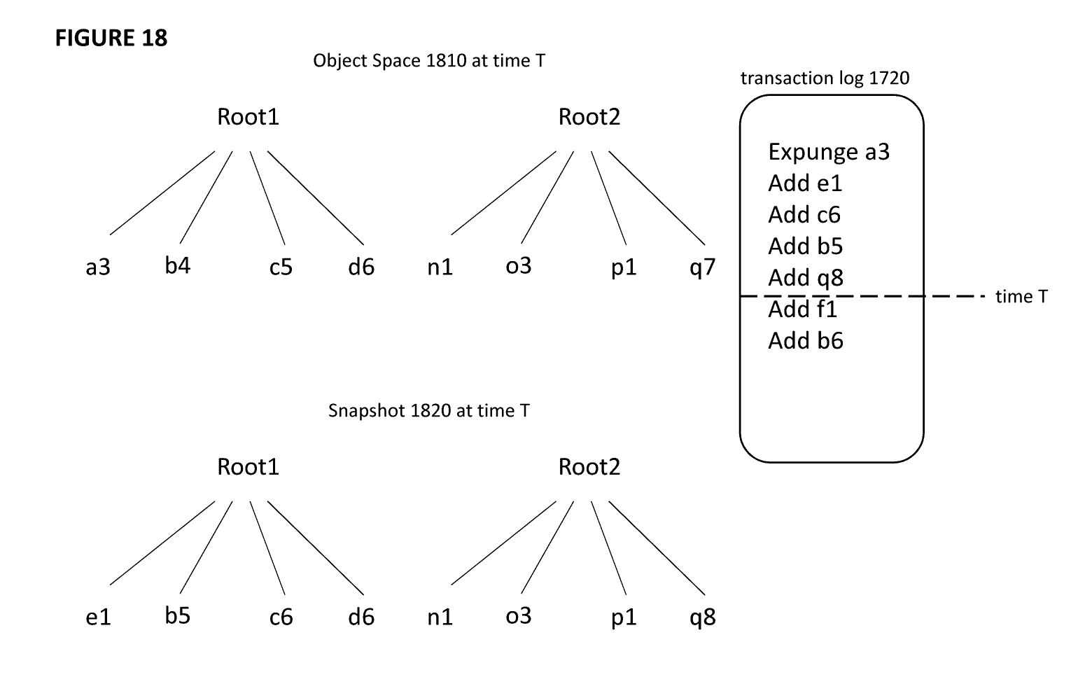

FIG. 17 depicts the snapshotted object space 1710 as a single tree structure (which might correspond, for example, to a branch in a directory structure within namespace manifest 210). However, snapshots are not limited to one tree, and actually can comprise a plurality of trees. Thus, in FIG. 18, the snapshotted object space 1810 comprises two trees, and as a result, snapshot 1820 also will comprise two trees, each of which reflects all pending transactions contained in transaction log 1720 at time T.

Clones of a Snapshot or of the Namespace or a Portion Thereof

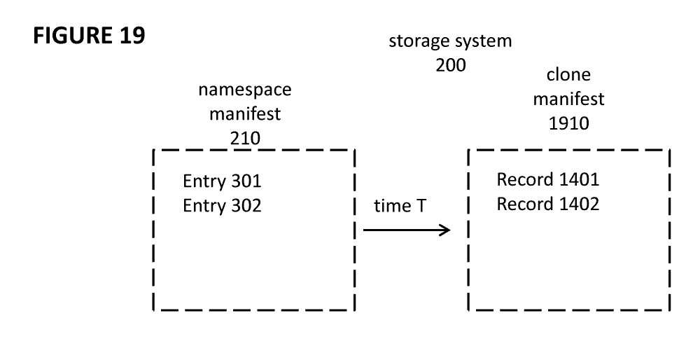

The embodiments all support the creation and usage of a clone manifest. In FIG. 19, clone manifest 1910 is created directly from namespace manifest 210 in the same manner that a snapshot manifest is created in FIG. 13. In FIG. 20, clone manifest 1910 is created from snapshot manifest 2010, and in that situation, will be an exact copy of snapshot manifest 2010 and will contain records following the structure of record 1510 in FIG. 15, with the addition of the clone manifest extension discussed below.

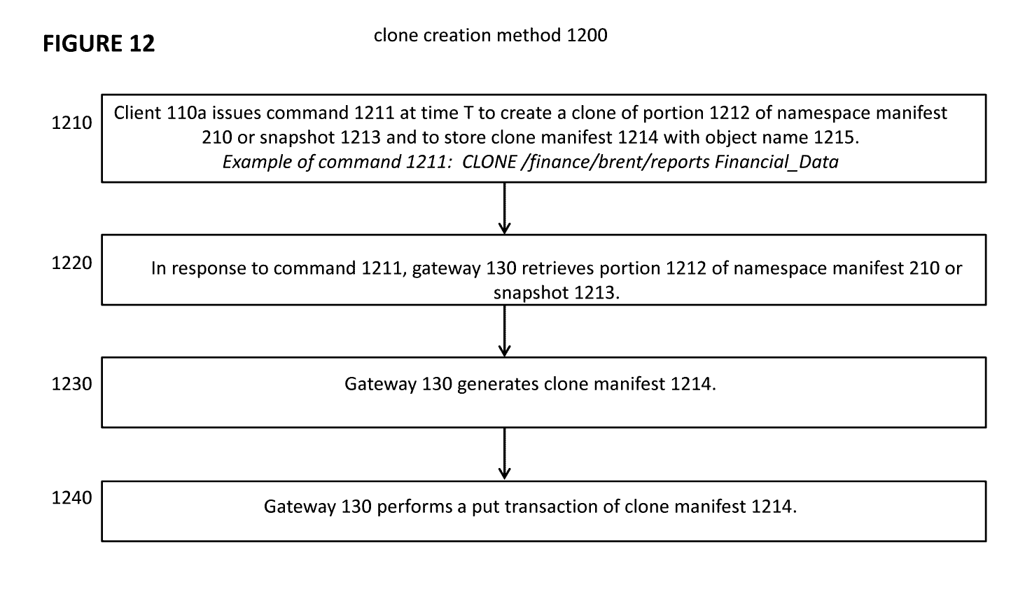

With reference to FIG. 12, clone creation method 1200 is depicted. Client 110a issues command 1211 at time T to create a clone of portion 1212 of namespace manifest 210 or snapshot 1213 and to store clone manifest 1214 with object name 1215 (step 1210). An example of command 1211 is: CLONE/finance/brent/reports Financial_Data. In this example, “CLONE” is the command, “/finance/brent/reports” is the identification of portion of the namespace to be cloned, and “Financial_Data” is the object name for the clone. Instead of identifying a portion of the namespace, the command instead can identify a snapshot to be cloned (e.g., “Financial Reports” from the example of FIG. 13). The command may be implemented in one of many different formats, including binary, textual, command line, or HTTP/REST.

In response to command 1211, gateway 130 retrieves portion 1212 of namespace manifest 210 or snapshot 1213 (step 1220). Gateway 130 then generates clone manifest 1214 (step 1230). Gateway 130 performs a put transaction of clone manifest 1214 (step 1240).

Clone Manifest Extension

The present invention requires an additional encoding within a clone manifest not found in a snapshot manifest. This encoding specifies zero or more delta chunk references that must be applied before this new version can be put to a snapshot manifest. In the preferred implementation an object specified with delta chunk references is only accessible through a clone manifest; it cannot be independently accessed using the object cluster directly. Putting to a snapshot manifest is functionally equivalent to pushing a local git repository to a master repository.

Each delta chunk references encodes:
The stage of the chunk reference:
   Untracked: This represents data within an untracked object. Untracked objects are not pushed to other Manifests.
   Modified: This represents data that the clone manifest was instructed to track and which has been modified, but which has not yet been committed.
   Committed: This represents data that is changed from the reference manifest but which has not yet been pushed to a snapshot manifest.
The same chunk reference options as previously described.

A delta chunk reference supplies content that is changed from the reference chunk. For sharded objects this is the existing payload chunk for the current shard. For objects within a clone manifest (that are not described in a shard chunk reference) the reference content is defined for the object version as a whole through a version manifest CHIT.

For each chunk reference type identified above there is an additional type to specify a Delta Chunk Reference to the same data. Additionally, the following chunk reference type must also be supported:
Inline Key/Value Edit: Key range to Delete, Inline Key/Value records to insert.

Clone Manifest Transactions

The following transactions must be supported to utilize a clone manifest:
Creating a clone manifest.
Putting Modifications to a clone manifest.
Committing a clone manifest to a snapshot manifest or to the mainline.
Abandoning a clone manifest.
Getting a List of Uncommitted Changes in a clone manifest.
Comparing a clone manifest to another clone manifest, a snapshot manifest or the mainline.

Creating a new clone manifest is identical to creation of a snapshot manifest, but with the addition of a system metadata attribute indicating that it is a clone manifest and can therefore be a reference for further updates.

The source for initial records is a filtered subset of a namespace manifest or an existing version of a snapshot manifest. Because a clone manifest is a snapshot manifest they can also be the source of initial records. The subset of records selected may be specified by any combination of the following:
Specification of a specific version of a snapshot manifest or clone manifest.
Selecting the current version of objects that comply with a certain wildcard mask.
Selecting all versions of objects that comply with a certain wildcard mask.
Selecting specific versions of objects by specifying the object name and its unique version identifier or generation.

An implementation may choose to accept the enumeration of specific version manifests in a format that is compatible with an existing command line program such as tar or git. Creating a clone manifest is the functional equivalent of creating a local repository with a git “clone” operation.

The created clone manifest will include metadata fields identifying;
The name of the clone manifest.
The Unique Version ID and Generation fields, as with any other object.

Putting Modifications to a Clone Manifest

A Clone Manifest Put Transaction applies changes to a set of objects within the scope of an existing snapshot manifest or clone manifest to create a new version of a clone manifest. No “working directory” is created because the clone manifest encodes the contents of the working directory by marking the delta chunk references as being “untracked” or “modified”.

The transaction specifies:
The version of a snapshot manifest or clone manifest that is the base for the modification. If a default is allowed it should be for the current version of the clone manifest.
The name of the clone manifest for which a new version is to be created. By default this is also the name of the reference manifest.
A set of one or more objects to be modified or inserted. For each:
   Name
   Zero or more key ranges to be deleted.
   Zero or more records to be inserted. These may be specified by value or with Chunk reference to previously created Payload Chunks.

For each modified object, an additional metadata field is kept with the clone manifest system metadata noting the original version manifest that was initially snapshot. Unlike a generic object put, a new version of a clone manifest does not become the current version by default. Only a commit operation can make a newly committed version the current version.

Putting modifications to a clone manifest is functionally equivalent to performing a git “add” operation on a local repository.

Editing Untracked Objects

Existing source control solutions such as Git and mercurial allow users to edit files in the working directory that will not be tracked by the revision control system. This is most frequently used to exclude files that are generated by a make operation, limiting revision tracking to source files. These are most often specified by wildcard masks, such as “*.o”. However the revision control system can ignore any name when it is configured to be “untracked”.

The present invention allows new objects to be created within the clone manifest that are in an “untracked” state. Untracked delta chunk references are never committed or pushed. When the clone manifest is finally abandoned, as explained in the next section, these changes will be lost. This is same result as when untracked files are forgotten when the working directory is finally erased.

The object is created when the object is opened or created, and each write creates a new “untracked” delta chunk reference, potentially overwriting all of part of previous delta chunk references. Read operations referencing this payload will receive these bytes, read operations referencing undefined content will receive all zeroes or for key/value records an explicit “no such key” error indication.

Committing a Clone Manifest

Committing a clone manifest creates a new version of the clone manifest, or optionally of a snapshot manifest, with the following extensions to the already described method of creating a snapshot or clone manifest:
Untracked objects are not committed, and will be eligible to be expunged after the clone manifest is expunged.
All staged chunk references (for tracked objects) are changed to committed chunk references.
One or more items of commit metadata are added that are specific to this version. These must include a commit message, but can include other commit metadata.

Committing a clone manifest without specifying a remote target is functionally equivalent to a git “commit” operation. Committing a clone manifest to another clone manifest or snapshot manifest is the equivalent of a git “push” operation to a bare repository.

Merging One or More Clone Manifests into the Main Tree

When the target is another clone manifest, or the mainline object store, it is necessary to reconcile edits already performed since the clone on the target with the accumulated edits in the clone.

When possible to do so without the same records or byte ranges being referenced the merge will be applied automatically by applying the delta in the clone manifest from its original version (when it split from the base that it is being re-merged with) to the current versions of objects in the merge target. This can be done on a per-shard basis.

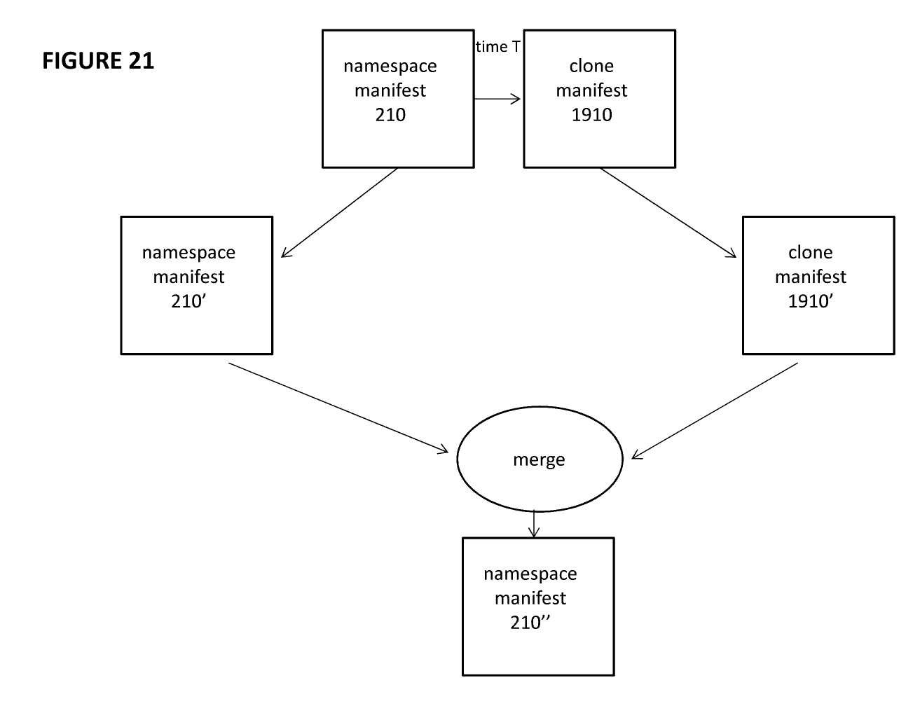

With reference to FIG. 21, clone manifest 1910 is created from namespace manifest 210 (or a snapshot manifest) at time T. Namespace manifest 210 continues to be used by clients, and clone manifest 1910 also is used by clients. Thus, at a later time (indicated by the ′ mark), both namespace manifest 210′ and clone manifest 1910′ exist. A user or administrator then can seek to merge clone manifest 1910′ back into namespace manifest 210′, and at a later time (indicated by the ″ mark), namespace manifest 210″ is created to reflect the merge between namespace manifest 210′ and clone manifest 1910′ using known merge techniques.

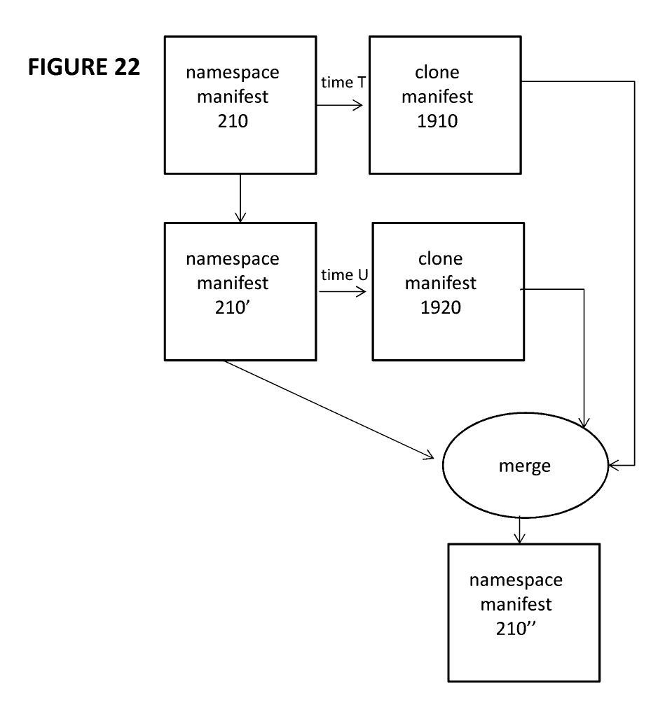

With reference to FIG. 22, multiple clone manifests can co-exist. At time T, clone manifest 1910 is created from namespace manifest 210 (or from a snapshot manifest). At time U, clone manifest 1920 is created from namespace manifest 210′ (or from a snapshot manifest). A user or administrator then can seek to merge clone manifest 1910 and clone manifest 1920 back into namespace manifest 210′, and at a later time (indicated by the ″ mark), namespace manifest 210″ is created to reflect the merge between namespace manifest 210′, clone manifest 1910, and clone manifest 1920 using known merge techniques.

Usage of Clones within Distributed Storage System

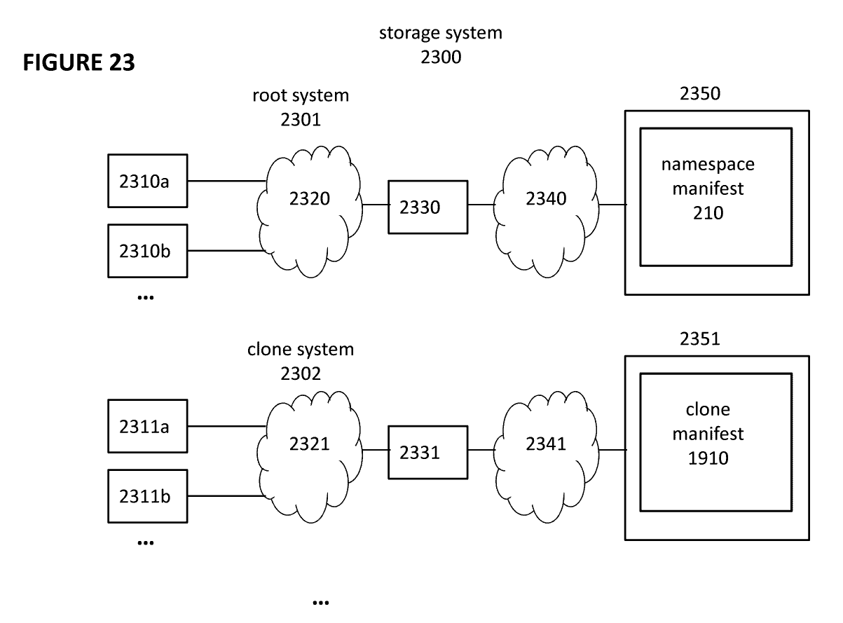

The use of clones allows for an extremely versatile storage system with the capability for scalable distributed computing and storage. FIG. 23 depicts storage system 2300, which comprises root system 2301 and clone system 2302.

Root system 2301 follows the architecture of FIG. 1 and comprises clients 2310a and 2310b, client access network 2320, gateway 2330, replicast network 2340, and storage sub-system 2350 (which comprises storage servers and storage devices as previous described). Namespace manifest 210 is stored in storage sub-system 2350 as namespace manifest shards (not shown). These components and couplings are exemplary, and it is to be understood that any number of them may be used in root system 2301.

Similarly, clone system 2302 follows the architecture of FIG. 1 and comprises clients 2311a and 2311b, client access network 2321, gateway 2331, replicast network 2341, and storage sub-system 2351 (which comprises storage servers and storage devices as previous described). Here, clone manifest 1910 is stored in storage sub-system 2351 as clone manifest shards (not shown).

Here, clone system 2302 is exemplary, and it should be understood that any number of clone systems can co-exist with root system 2301.

The devices and connections of root system 2301 and clone system 2302 can overlap to any degree. For example, a particular client might be part of both systems, and the same storage servers and storage devices might be used in both systems.

Abandoning a Clone Manifest

A clone manifest can be abandoned by expunging the specific version, using the same approach used for expunging any object.

Implementing File Archives Using Clone Manifests

A clone manifest can be used to manage a set of named objects that have never been put as distinct objects to the main tree of the object storage system. These are pending edits for new objects created in a clone manifest. The user can get or put these objects using the clone manifest much as they could get or put a file to a .tar, .tgz or .zip archive.

Implementing Files or Volumes Over Objects Using Clone Manifests

One use of the present invention is to efficiently implement a file or block interface to logical volumes over an object store.

Typically, volumes are already under management plane control for a given storage domain where the management plane assigns the exclusive right to mount a volume for write to a single entity such as a virtual machine. In the present invention, this assignment may be to a library in the end instance itself or to a proxy acting on behalf of the end instance.

Files, by contrast, typically have an existing network access protocol such as NFS (Network File System) which has pre-existing rules for determining which instance of a file system has the right to update specific portions of the namespace. The file access daemon would apply standard procedures to obtain the necessary rights to modify portions of the namespace under existing protocols. The present invention innovates in how those edits are applied to object storage, not in any of the file sharing protocol exchanges over the network.

In either case, the agent creates a clone manifest of the reference version manifest or snapshot manifest, and then applies updates to the clone manifest. Use of the Block Shard Chunk Reference, discussed in the Incorporated References, can be useful when updating byte array objects with random partial writes.

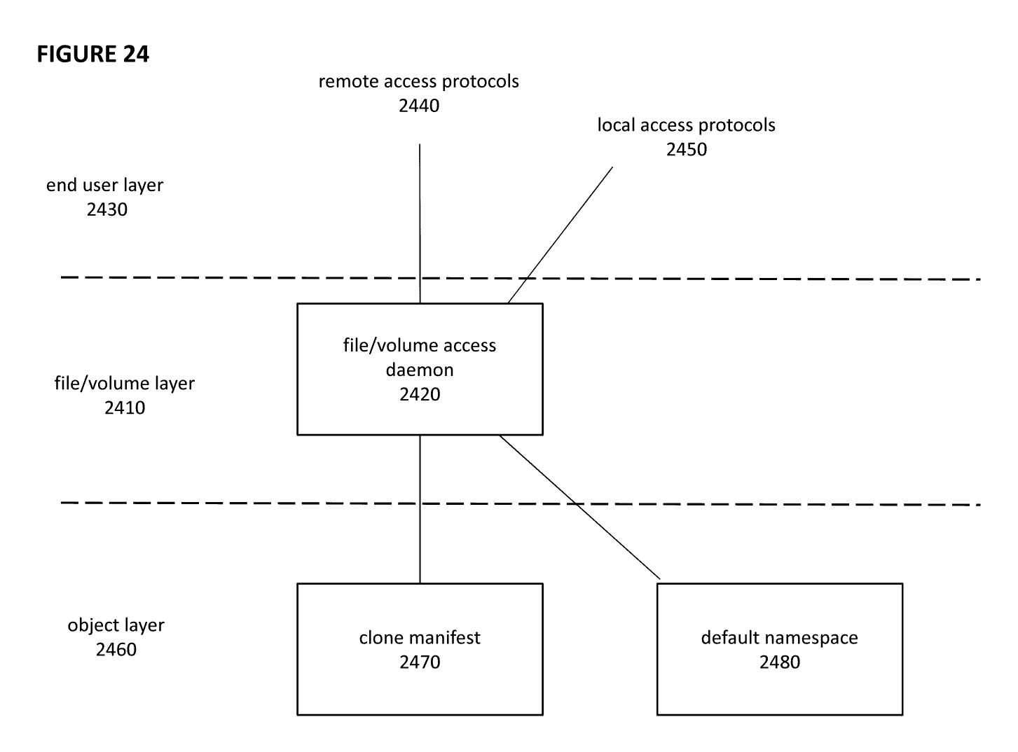

FIG. 24 depicts a file or block access daemon implemented on a gateway server. The file/volume access layer 2410 implemented by a process 2420 (frequently labelled as a “daemon”) interfaces to the end user layer 2430, where users can use a client to access storage using remote access protocols 2440 or local access protocols 2450. Process 2420 implements access to storage via calls to the object services layer 2460. Portions of the accessed namespace which are subject to modification are mapped to clone manifests 2470, while other typically read-only accesses default to default namespace 2480.

Changes are only committed back to the default namespace 2480 when the user wants to make the accumulated changes visible to subsequent users of the file/volume access layer 2410. This would typically be done when committing before unmounting a volume or file system, but could be done at extra commit points chosen by the user as well.

Block Shard Chunk Reference

A Block Shard Chunk Reference defines a shard as being a specific range of bytes for the object, and then specifying the CHIT for the current version's Payload or Manifest Chunk for this shard.

Block Shards are useful for performing edits for byte ranges for open volumes or files using clone manifests. The put transaction can supply the specifically modified range, and have the targeted storage servers create a new Chunk which replaces the specified range and supply the new CHIT for the shard. This can be implemented using the foregoing embodiments and is a specific use case for those embodiments.

What is claimed is:

1. A method for asynchronously creating a snapshot in a distributed storage system at a specified time T, the distributed storage system comprising a plurality of storage servers, wherein each storage server comprises one or more storage devices, the method comprising:
maintaining one or more namespace manifests, each namespace manifest comprising one or more records associated with each object in a subset of objects stored in the distributed storage system, each namespace manifest stored as one or more namespace manifest shards stored by one or more storage servers;
receiving a snapshot command from a snapshot initiator to create a snapshot of all of or part of a specified namespace manifest at a time T, the snapshot comprising immutable references to versions that were current at time T of a plurality of objects;
from each storage server holding a namespace manifest shard associated with the all of or part of the specified namespace manifest, after waiting for transactions timestamped at or before time T to complete, extracting records referencing the current version at time T of each object included in the namespace manifest shard and assigning each of the records to a portion of a snapshot manifest;
for each portion of the all of or part of the specified namespace manifest: accumulating, by each storage server holding a namespace manifest shard, a plurality of records to be added to each portion of the snapshot manifest in a batch; performing, by the storage server that performed the accumulating, a put operation of the batch to a multicast group of storage servers; merging a plurality of received batches at a storage server to create a chunk holding the portion of the snapshot manifest; calculating the cryptographic hash identifying token (CHIT) for the chunk; and reporting the CHIT to the snapshot initiator; and
accumulating, by the snapshot initiator, CHITs for each portion of the snapshot manifest and creating a version manifest for the snapshot.

2. The method of claim 1, wherein creating the snapshot does not result in a delay or denial of concurrent put or get operations within the cluster and does not reduce the integrity of the snapshot or the cluster.

3. The method of claim 1, wherein the snapshot command comprises:
a textual command;
an identification of the object space that is the subject of the snapshot; and
a name for the snapshot.

4. The method of claim 1, wherein the snapshot manifest captures a specified subset of the objects referenced within the specified namespace manifest, wherein the subset may be specified by a rule or by enumeration.

5. The method of claim 4, wherein each of the immutable references within a namespace record comprises a cryptographic hash of the contents of a metadata chunk specifying metadata and enumerating referenced chunks.

6. The method of claim 4, wherein the snapshot manifest comprises a plurality of records, each record comprising:
a name mapping; and
a version manifest identifier.

7. The method of claim 6, wherein each record further comprises:
information indicating whether a sub-directory exists.

8. A method for editing a set of objects included in a snapshot manifest or a namespace manifest through use of a clone manifest, wherein the edits applied to this set are isolated from the default access to these objects, the clone manifest extending the snapshot manifest or namespace manifest with the addition of zero or more namespace records encoding edits not yet applied to version manifests, the method comprising:
maintaining one or more namespace manifests, each namespace manifest comprising one or more records associated with each object in a subset of objects stored in the distributed storage system, each namespace manifest stored as one or more namespace manifest shards stored by one or more storage servers;
receiving a clone command to create a clone of all of or part of a specified namespace manifest at a time T;
retrieving a first set of data comprising all or part of the specified namespace manifest;
retrieving a second set of data from one or more storage servers comprising metadata associated with pending transactions in the storage server as of time T;
creating a clone manifest based on the first set of data and the second set of data; and
storing the clone manifest as an object in the storage system.

9. The method of claim 8, wherein the clone command comprises:
a textual command;
an identification of the object space that is the subject of the clone; and
a name for the clone.

10. The method of claim 8, further comprising:
receiving a put transaction from a merge; and
updating the clone manifest in response to the put transaction.

11. The method of claim 10, further comprising:
receiving a merge transaction from a client; and
merging the clone manifest with the specified namespace manifest.

12. The method of claim 10, further comprising:
receiving a merge transaction from a client; and
generating a snapshot manifest based on a merge of the clone manifest and the specified namespace manifest.

13. A method of performing partial updates of blocks within a virtual volume using clone manifests, the method comprising
storing an object representing a virtual volume in a main tree of a distributed storage system;
creating a clone manifest for the object, where each logical block of the virtual volume is encoded as a chunk shard reference, whereby each logical block remains in the same negotiating group even when its payload is modified;
dispatching, by a transaction initiator, edits of a portion of a logical block to the storage servers holding the current version of the logical block as a multicast modifying put request;
merging, by the storage servers holding the current version of the logical block, the edits with the referenced chunk to form a new chunk and reporting a new content hash identifying token (CHIT) to the transaction initiator;
validating successful completion of the edits by comparing the resulting CHITs to verify that each storage server applied the edits to result in the same final chunk;
updating the CHIT, by the transaction initiator, for each shard of the virtual volume before performing a named put to create a new version of the object containing the logical block within a new version of the clone manifest; and
merging the new version of the clone manifest with the main tree of the distributed storage system.

14. A method of performing partial updates of a virtual file encoded as an object using clone manifests, the method comprising:
storing an object representing a virtual file in a main tree of a distributed storage system;
creating a clone manifest including the object representing the virtual file, where the virtual file content is encoded as chunk shard references, whereby a given offset range within the virtual file will remain in the same negotiating group if a payload of that given offset range is modified;
dispatching partial edits of a portion of the given offset range to the storage servers holding the current version of the given offset range as a multicast modifying put request;
merging, by each storage server holding the given offset range, the modified content with the referenced chunk to form a new chunk, and then reporting a new content hash identifying token (CHIT) to the transaction initiator;
validating successful completion of the edits by comparing the resulting CHITs to verify that each storage server applied the edits to result in the same final chunk;
updating the CHIT, by the transaction initiator, for each shard of the virtual file before performing a named put to create a new version of the object within a new version of the clone manifest; and
merging the new version of the clone manifest with the main tree of the distributed storage system.

15. A method for creating a clone in a distributed storage system comprising one or more storage servers each coupled to one or more storage devices, the method comprising:
maintaining one or more namespace manifests, each namespace manifest comprising one or more records associated with each object in a subset of objects stored in the distributed storage system, each namespace manifest stored as one or more namespace manifest shards stored by one or more storage servers;
retrieving a first set of data comprising all or part of a specified namespace manifest;
retrieving a second set of data from one or more storage servers comprising metadata associated with pending transactions in the storage server as of time T;
creating a snapshot manifest based on the first set of data and the second set of data;
receiving a command to create a clone of all of or part of the snapshot manifest;
creating a clone manifest based on the snapshot manifest; and
storing the clone manifest as an object in the storage system.

16. The method of claim 15, wherein the snapshot command comprises:
a textual command;
an identification of the object space that is the subject of the clone; and
a name for the clone.

17. The method of claim 15, further comprising:
receiving a put transaction from a client; and
updating the clone manifest in response to the put transaction.

18. The method of claim 17, further comprising:
receiving a merge transaction from a client; and
merging the clone manifest with the specified namespace manifest.

19. The method of claim 17, further comprising:
receiving a merge transaction from a client; and
generating a snapshot manifest based on a merge of the clone manifest and a namespace manifest.

20. An object storage system, comprising:
a plurality of gateways providing access to cluster services for one or more clients; and
a plurality of storage servers, each of the storage servers maintaining a local transaction log that is updated in response to put and delete transactions from the plurality of gateways, wherein the plurality of storage servers collectively implement:
one or more namespace manifests, each namespace manifest comprising one or more records associated with each object in a subset of objects stored in the distributed storage system, each namespace manifest stored as one or more namespace manifest shards stored by one or more storage servers; and
a snapshot manifest stored as a plurality of snapshot manifest shards by one or more of the plurality of storage servers, wherein the snapshot manifest comprises a plurality of entries, each entry derived from an entry in a namespace manifest that resulted from a transaction initiated before a time at which the command to create the snapshot manifest was received.

21. An object storage system, comprising:
a plurality of gateways providing access to cluster services for one or more clients; and
a plurality of storage servers, each of the storage servers maintaining a local transaction log that is updated in response to put and delete transactions from the plurality of gateways, wherein the plurality of storage servers collectively implement:
one or more namespace manifests, each namespace manifest comprising one or more records associated with each object in a subset of objects stored in the distributed storage system, each namespace manifest stored as one or more namespace manifest shards stored by one or more storage servers; and
a clone manifest stored as a plurality of clone manifest shards by one or more of the plurality of storage servers, wherein the clone manifest comprises entries derived from entries in all or part of a namespace manifest, or from entries in a snapshot manifest at a time the command to create the clone manifest was received.
